(19) United States
(12) Patent Application Publication
(10) Pub. No.: US 2017/0011462 A1
(43) Pub. Date: Jan. 12, 2017

(54) GUARANTEED INCOME SYSTEM AND METHOD

(71) Applicant: PRINCIPAL FINANCIAL SERVICES, INC., Des Moines, IA (US)

(72) Inventors: Alyse ANLIKER, Urbandale, IA (US); Carmen BROWN, Ankeny, IA (US); Noelle FOX, Waukee, IA (US); Randal MAIFELD, Pella, IA (US); Robert MATHEWS, Des Moines, IA (US); Bobbi PERKINS, Adel, IA (US); Carrie STOUT, Pleasant Hill, IA (US)

(21) Appl. No.: 15/206,048

(22) Filed: Jul. 8, 2016

Related U.S. Application Data
(60) Provisional application No. 62/190,181, filed on Jul. 8, 2015.

(51) Int. Cl. G06Q 40/06

(52) U.S. Cl. CPC G06Q 40/06

(57) ABSTRACT

Some embodiments include a system and method of a guaranteed income including execution of a browser program to deliver pension plan financial content on a local or consumer device, and displaying at an option of a financial structure of a financial portfolio. The financial portfolio includes an allocation to an investment option selectable as part of a pension. Some embodiments include coupling to an investment database including pre-modeling investment data, and to a third-party source of financial models based on the pre-modeling investment data. The operations include calculating and displaying a pension glide path option or scenario including a representation of how the financial portfolio will be managed over time based on the financial models. Purchase cost options are calculated based on a user's target date input, and a guaranteed income pension is calculated based on the financial models, the target date, and/or a user's purchase selection.

### RELATED APPLICATIONS

This application claims priority to U.S. Provisional Patent Application Ser. No. 62/190,181, filed on Jul. 8, 2015, the entire contents of which are incorporated herein by reference.

### BACKGROUND

As retirement plan participants approach retirement, their goals change from saving as much money as possible to protecting their savings and creating income to last throughout retirement. Research has shown that most people plan to retire at 65 or later. However, health and other events often prevent them from working for that long, and the Society of Actuaries has observed age 62 is the average retirement age in the United States. With longevities rising overall, combined with low levels of retirement savings, and an increasing burden of healthcare costs, many plan participants are searching for financial options that can provide a predictable monthly income, impervious to market and global instability, that is guaranteed for the life of the participant.

Lifetime annuities are available. However, participants are often required to purchase the entire annuity as a lump sum on a specific date without an opportunity for dollar-cost averaging. Moreover, annuity purchases are typically independent of a potential participant's conventional retirement savings such as ROTH or non-ROTH 401(k) or IRA accounts.

### SUMMARY

Some embodiments include a guaranteed income server system comprising a computing device comprising at least one processor, a non-transitory computer readable medium, having stored thereon, instructions that when executed by the computing device, cause the computing device to perform at least some operations within a local or consumer device. The operations comprise at least execution of a browser program to deliver pension plan financial content on the local or consumer device, and displaying at least one selectable option of a financial structure of a financial portfolio, the financial portfolio including an allocation to at least one investment option selectable as part of a pension. Further, the operations comprise coupling to an investment database comprising pre-modeling investment data, and to a third-party source of financial models, where the financial models are based at least in part on the pre-modeling investment data. Further, the operations comprise calculating and displaying at least one pension glide path option or scenario comprising a representation of how the financial portfolio will be managed over time based at least in part on at least one of the financial models. The operations also comprise receiving at least a target date input from a user through the local or consumer device, calculating and displaying purchase cost options based on the target date input, receiving at least one purchase selection, and storing the received purchase selection in a data repository. Further, the operations comprise calculating and displaying at least one pension glide path of the pension based at least in part on at least one of the financial models, the target date, and the at least one purchase selection.

In some embodiments of the invention, the at least one purchase comprises at least one lump sum purchase. In some further embodiments, the at least one purchase comprises at least one payroll income purchase that comprises a value defined by at least one of the financial models based on the target date and any lump sum payment by the customer.

In some embodiments, the at least one purchase comprises customer funds transferred from one or more existing investment accounts of the customer. In some embodiments, the existing investment accounts comprise a plurality of investments, and where the customer funds are transferred proportionally to make the purchase.

Some embodiments comprise providing an option to redeem at least a portion of a pension. Further, in some embodiments, upon a redemption, the at least one pension glide path of the pension is recalculated based at least in part on the at least one purchase selection and a redeemed portion of the pension. In some embodiments, a redemption can trigger a redemption surcharge based at least in part on one or more rules of the pension.

In some embodiments, the target date investment option includes at least one investment or investment plan structured or defined by a specified retirement target date. In some further embodiments, the at least one pension glide path option or scenario includes a display of a financial data chart and/or a financial data table.

In some embodiments, the financial data chart or financial data table includes a display of purchased income and resulting total income as a function of the customer's age and time period. Some embodiments include a time period that comprises a monthly time period for purchased income and resulting total income as a function of the customer's age.

In some embodiments, the pension comprises a deferred income annuity and/or a target date investment fund. In some further embodiments, the deferred income annuity comprises a QLAC annuity, an irrevocable annuity, and/or an immediate annuity. In some embodiments, the purchase selection comprises a purchase amount provided by the customer. In some embodiments, the purchase selection comprises an employer profit sharing contribution and/or matching contribution.

In some embodiments, the employer profit sharing contribution and/or matching contribution is directed by a plan sponsor. In some further embodiments, the at least one pension glide path option or scenario is structured based on a fixed allocation model.

Some embodiments include a pension glide path option or scenario that is structured based on a glide path that includes provisions to prepare an increasingly conservative financial portfolio as the customer's age approaches the target date.

Some embodiments include a guaranteed income method comprising providing a computing device comprising at least one processor, and providing a non-transitory computer readable medium, having stored thereon, instructions that when executed by the computing device, cause the computing device to perform at least some operations within a local or consumer device. The operations include execution of a browser program to deliver pension plan financial content on the local or consumer device, and displaying at least one selectable option of a financial structure of a financial portfolio. The financial portfolio includes an allocation to at least one investment option selectable as part of a pension. Some embodiments include coupling to an investment database comprising pre-modeling investment data, and to a third-party source of financial models, where the financial models are based at least in part on the pre-modeling investment data. The operations include calculating and displaying at least one pension glide path option or scenario comprising a representation of how the financial portfolio will be managed over time based at least in part on at least one of the financial models. The operations include receiving at least a target date input from a user through the local or consumer device. The operations include calculating and displaying purchase cost options based on the target date input. The operations include receiving at least one purchase selection, storing the received purchase selection in a data repository, and calculating a guaranteed income pension based at least in part on at least one of the financial models, the target date, and the at least one purchase selection.

### DESCRIPTION OF THE DRAWINGS

FIG. 1 illustrates a guaranteed income system and method in accordance with some embodiments of the invention.

FIG. 2 illustrates a guaranteed income system and method in accordance with some embodiments of the invention.

FIG. 3 illustrates a guaranteed income process architecture in accordance with some embodiments of the invention.

FIG. 4 illustrates an example of a computer system used by the guaranteed income process architecture of FIG. 3 and the guaranteed income system and method of FIGS. 1 and 2 in accordance with some embodiments of the invention.

FIG. 5 shows an example of guaranteed income as a function of a plurality of income transfer purchases in accordance with some embodiments of the invention.

FIG. 6 shows an example of guaranteed income with total monthly income purchased as a function of a plurality of income transfer purchases in accordance with some embodiments of the invention.

FIG. 7 provides an illustration of a projection of a monthly retirement income in accordance with some embodiments of the invention.

FIG. 8 illustrates a dashboard with quote functionality in accordance with some embodiments of the invention.

FIG. 9 illustrates a window of a first step of a transfer process including a purchase in accordance with some embodiments of the invention.

FIG. 10 illustrates a window of a second step of a transfer process including a purchase in accordance with some embodiments of the invention.

FIG. 11 illustrates a window of a third step of a transfer process including a transfer and purchase summary in accordance with some embodiments of the invention.

FIG. 12 illustrates a window of a fourth step of a transfer process including a confirmed purchase in accordance with some embodiments of the invention.

FIG. 13 illustrates a window of a first step of a transfer process including surrender in accordance with some embodiments of the invention.

FIG. 14 illustrates a window of a second step of a transfer process including surrender in accordance with some embodiments of the invention.

FIG. 15 illustrates a window of a third step of a transfer process including a surrender in accordance with some embodiments of the invention.

FIG. 16 illustrates a window of a fourth step of a transfer process including surrender in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments, and of being practiced or of being carried out in various ways. Also, it is to be understood that the phraseology and terminology used herein is for the purpose of description, and should not be regarded as limiting. The use of “including,” “comprising,” or “having” and variations thereof as used herein is meant to encompass the items listed thereafter and equivalents thereof, as well as additional items. Unless specified or limited otherwise, the terms “mounted”, “connected”, “supported”, “coupled”, and variations thereof are used broadly and encompass both direct and indirect mountings, connections, supports, and couplings. Further, the terms “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Guaranteed income provides a new diversification option for retirement plan participants. As participants near retirement, they can begin converting their savings to income by purchasing slices of guaranteed income for life. Using this process, plan participants can turn their savings into a pension that comprises income payments guaranteed for life, where a participant can choose their income start date, the form of the annuity, and the payment frequency, including for example by receiving monthly, quarterly, semi-annually, or annual payments.

In some embodiments, one or more guaranteed income products, including products derived from the systems and methods described herein, can help participants manage financial risk. For example, one or more guaranteed income products, including products derived from the systems and methods described herein can manage risk by managing a participant's total portfolio risk (i.e., a portfolio consisting of all of the liquid assets of a participant including one or more defined contributions plans, but not limited to, one or more traditional or ROTH 401(k) plans, 401(a) profit sharing plans, one or more traditional and/or ROTH IRAs, one or more government or company pension incomes, one or more brokerage accounts, one or more interest-bearing bank accounts, one or more 403(b) plans, and one or more 457 plans, etc.)

Some embodiments of the invention comprise the guaranteed income system and method 10 generating an in-plan deferred income annuity. In some embodiments, retirement plan participants nearing retirement can diversify their retirement assets by using a portion of their defined contribution plan account balance and/or contributions to purchase guaranteed income for life in retirement. For example, in some embodiments of the invention, defined contribution plan sponsors can utilize money purchase, profit sharing, 401(k), 403(b plans to enable retirement plan participants nearing retirement to diversify their retirement assets by using portions of the account balances and/or contributions to purchase guaranteed income for life in retirement. In some embodiments, the guaranteed income system and method 10 can enable a participant to use defined contribution plan balances to purchase slices of retirement income. For example, in some embodiments, a participant can make ad hoc purchases by using a portion of their current account balance to purchase the deferred income annuity (e.g., which will work like an investment transfer). In some further embodiments, a participant can also make a deferred income annuity part of investment direction for contributions (with each contribution to plan, and a certain percentage, as set by participant, allocated to purchase deferred income annuity). In this instance, participants can see the accumulated retirement income they have purchased, and the amount of “premium” they have used to make the purchases. In some further embodiments, once the participant is eligible for an in-service withdrawal or distributable event, the participant can elect to have the right/certificate to the annuity transferred out of the plan to them.

In some embodiments, guaranteed income can provide for longevity protection, and can be secured for specific retirement needs. For example, a guaranteed income portion of a participant's total portfolio can be used to help provide for housing and/or healthcare expenses. In some instances, guaranteed income can help to manage volatility by incrementally reducing market and interest rate risk to a participant's current and future income stream. As a further aid to retirement income planning, some embodiments include a retirement budget calculator configured to help participants estimate what they may need to cover essential expenses. Based on the results of that calculator, they could choose to purchase guaranteed income in amounts targeting covering one or more of those budgeted expenses.

In some embodiments, one or more guaranteed income products, including products derived from the systems and methods described herein, can help participants diversify income sources. For example, in some embodiments, one or more guaranteed income products, including products derived from the systems and methods described herein, can create an additional and/or alternative type of income stream from a participant's retirement plan.

In some embodiments, one or more guaranteed income products, including products derived from the systems and methods described herein, can help participants transition from a defined contribution approach to a defined benefit type of retirement income strategy. For example, in some embodiments, a portion of the participant's account balance can be used to purchase a known, guaranteed stream of income. In some embodiments, the remainder of the account balance can be available for the potential to continue to grow over time in the market. In some embodiments, at retirement, the participant can choose to create a separate income stream, or use the account balance to meet other goals and needs.

In some embodiments, one or more guaranteed income products, including products derived from the systems and methods described herein, can help participants maintain flexibility and control. For example, in some embodiments, a participant can direct how much to put into a guaranteed income vehicle and how to allocate their remaining account among available investment options. Some embodiments, paired with a target date investment option, can provide a more conservative and predictable approach as participants near retirement.

In some embodiments of the invention, one or more guaranteed income products, including products derived from the systems and methods described herein, can help participants maintain guaranteed income that can be predictable for life. Further, in some embodiments, the amount of guaranteed income secured is known with each purchase (i.e., at the time of a lump sum non-recurring purchase, the participant can be shown the amount of guaranteed income that will be added to any current guaranteed income that is part of the plan).

In some embodiments, various product features can be chosen in an effort to provide a higher guaranteed income benefit. In some embodiments, a participant can be provided with options to maintain investment control. For example, in some embodiments, the participant can choose how much and when to purchase guaranteed income. Further, in some embodiments, the participant can have the option to invest any remaining assets as desired.

In some embodiments of the invention, one or more guaranteed income products, including products derived from the systems and methods described herein, can help a participant manage risks. In some embodiments of the invention, guaranteed income products can help to manage volatility by incrementally reducing interest rate risk to a participant's current and future income stream. Further, in some instances, some embodiments of guaranteed income products can help to manage volatility by incrementally reducing stock market risk to a participant's current and future income stream. For example, in some embodiments, the guaranteed income products can help to manage stock market and event-type risk by dollar cost averaging annuity purchase rates over time (driven by age and interest rates). In some embodiments, this can protect against market losses, and reduce event risk. For example, using one or more guaranteed income products derived from the systems and methods described herein, a participant can incrementally build a future guaranteed income stream while being less concerned with the valuation level of the stock market (which may not be the case when a participant decides to purchase a single premium annuity.) In some embodiments, the systems and methods described herein can help to diversify the type, distribution, and risk of a participant's retirement portfolio by enabling at least some portion of a participant's contribution plan account to be converted to a pension-like or guaranteed income stream.

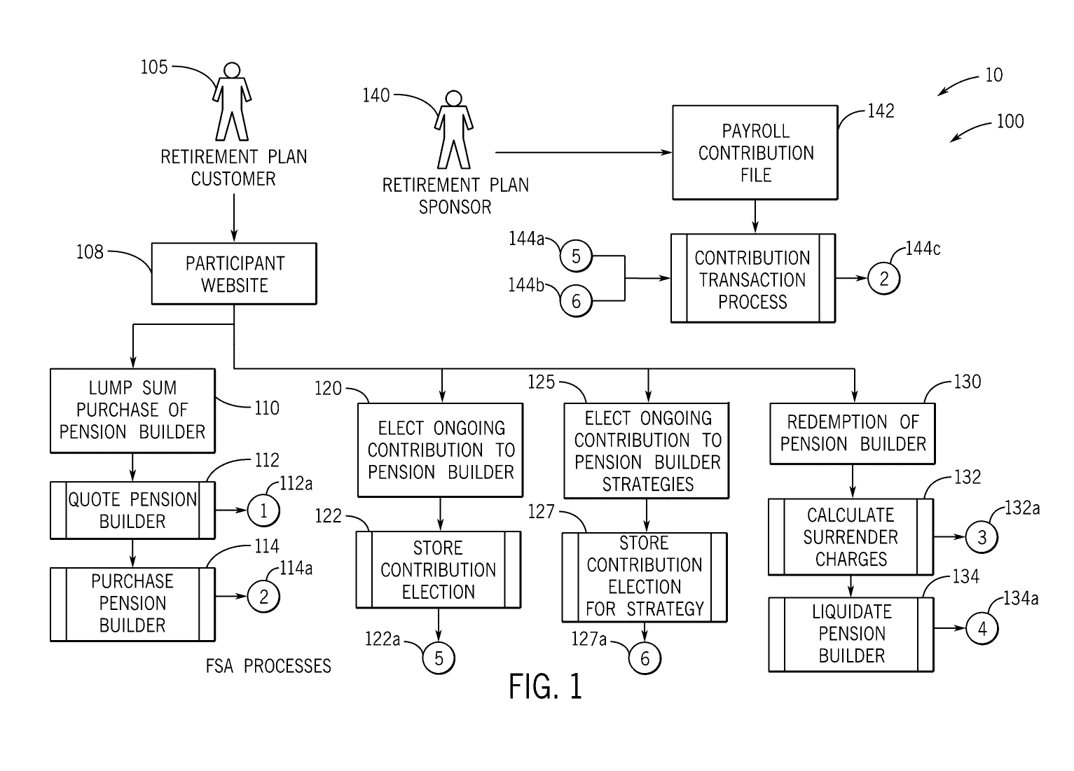

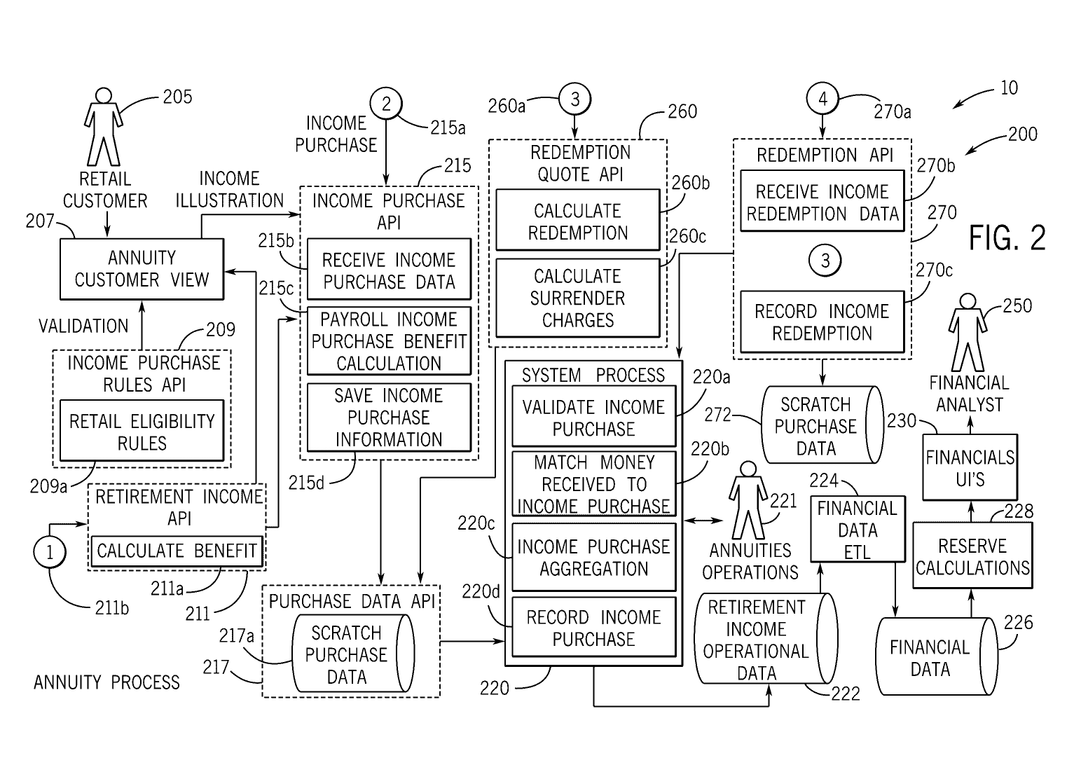

FIGS. 1 and 2 illustrate processes of a guaranteed income system and method 10, including retirement plan processes 100 and annuity processes 200. In some embodiments, a user, such as a retirement plan participant 105 or a retail customer 205 can access one or more guaranteed income products using the retirement plan processes 100 shown in FIG. 1, and in FIG. 2 (e.g., showing annuity process 200 of the guaranteed income system and method 10 in accordance with some embodiments of the invention). For example, in some embodiments, a retirement plan customer 105 can access one or more guaranteed income products using the retirement plan processes 100 of the guaranteed income system and method 10 shown in FIGS. 1 and 2. For example, in some embodiments, customers can access the guaranteed income system and method 10 through a website or other electronic medium including any conventional website. Further, in some embodiments, using an online portal for example, a customer can couple to an annuity process (FIG. 2) that can be configured to process an income purchase for the customer as discussed in further detail below.

Referring initially to FIG. 1, in some embodiments of the invention, a retirement plan customer 105 can access, view, enter or logon to the guaranteed income system and method 10 through the participant website 108. In some embodiments, once the retirement plan customer 105 enters the participant website 108, the customer 105 can be directed to a number of purchase or contribution options processed through various modules of the guaranteed income system and method 10. For example, in some embodiments, the guaranteed income system and method 10 can enable the retirement plan customer 105 to initiate a lump sum purchase option 110. In some embodiments, once the customer elects to proceed with a lump sum purchase option 110, the guaranteed income system and method 10 can process a quote 112 that can be used within the annuity process 200 shown in FIG. 2 using data 112a. Furthermore, once the guaranteed income system and method 10 processes a quote, the guaranteed income system and method 10 can process a purchase 114 through the annuity process using data 114a.

In some further embodiments of the invention, after the retirement plan customer 105 enters the participant website 108, the guaranteed income system and method 10 can enable the customer 105 to elect an ongoing pension contribution 120. The guaranteed income system and method 10 can store the contribution election 122 and data 122a can be processed by the annuity process 200. In some embodiments of the invention, after the retirement plan customer 105 enters the participant website 108, the guaranteed income system and method 10 can enable the customer 105 to elect an ongoing contribution to a pension strategy 125. The guaranteed income system and method 10 can store the contribution election 127 and data 127a can be processed by the annuity process 200.

In some further embodiments of the invention, after the retirement plan customer 105 enters the participant website 108, the guaranteed income system and method 10 can enable the retirement plan customer 105 to initiate a redemption option 130. In some embodiments, if a customer selects a redemption option 130, the guaranteed income system and method 10 can process a redemption within the annuity process shown in FIG. 2. Furthermore, once the guaranteed income system and method 10 processes and calculates surrender charges 132 with data 132a entering the annuity process 200.

Referring to the annuity processes 200 of the guaranteed income system and method 10 in FIG. 2, in some embodiments, a retail customer 205 can enter an annuity customer view 207. In some embodiments, the annuity customer view 207 can be provided to a retail customer 205 using an online portal. For example, in some embodiments, the retail customer 205 can access the annuity customer view 207 using one or more display-enabled devices such as through a personal computer, laptop, tablet, smart phone, or other technology that has not yet been developed.

In some embodiments, the guaranteed income system and method 10 can comprise at least one application program interface (hereinafter “API”) that can be configured to process and/or display information to at least one user using any of the aforementioned display-enabled devices. In some embodiments, the API can be used to enter information into any of the processes of the retirement plan processes 100 and/or the annuity processes 200. For example, some embodiments include a guaranteed income system and method 10 that can comprise at least one API 209 that is configured to provide a retail eligibility rules calculation for the retail customer 207 (shown as 209a).

Some embodiments of the invention include income purchase rules API can be used as part of a validation process using specific retail eligibility rules. Further, in some embodiments, the retail customer 207 can access retirement benefits information, including providing options for income illustrations. In some embodiments, once the customer elects to proceed with a lump sum purchase option 110, the guaranteed income system and method 10 can process a quote 112 that can be used within the annuity process 200 shown in FIG. 2 using data 112a. In some embodiments, the data 112a can comprise data 211b provided to a retirement income API 211, from which a retirement benefit can be calculated (process 211a). In some embodiments, the calculation can be displayed in the annuity customer view 207 and/or fed into the income purchase API 215.

In some embodiments, the retirement income API 211 can couple to the income purchase API 215 configured to process an income purchase for the retail customer 205 as mentioned earlier. In some embodiments, this can occur in tandem with the retail customer 205 accessing and receiving an income illustration (i.e., during an online session where a retail customer 205 has received information related to retail eligibility and/or information related to a projected retirement income.) In other embodiments, the retail customer 205 can opt to proceed directly with an income purchase.

In some embodiments, after processing a lump sum purchase option 110, the guaranteed income system and method 10 can process a quote 112, and the guaranteed income system and method 10 can process a purchase 114 through the annuity process using data 114a as input data 215a into the income purchase API 215. In some embodiments, the income purchase API 215 can receive income purchase data 215b, process a payroll income purchase benefit calculation 215c, and/or save income purchase information 215d.

In some embodiments, the guaranteed income system and method 10 can be configured to process annuity purchases in a batch and/or as ad hoc or scheduled purchases. For example, in some embodiments, annuity purchases for at least one retail customer 205 and/or at least one retirement plan customer 105 can be processed in a batch. In some other embodiments, annuity purchases for at least one retail customer 205 and/or at least one retirement plan customer 105 can be processed ad hoc at a date and time chosen by the customer 105, 110.

In some embodiments, single purchases including ad hoc transfers and ad hoc purchases of income and client initiated transfers to purchase income. In some embodiments, when an investment transfer or contribution is directed to the product, such transfer or contributions can be comprised of more than one money type under the retirement plan. These money types could include Roth, non-Roth, pre-tax employee or employer, after-tax, etc. A separate annuity purchase is made for each money type and a record is kept accordingly so that vesting, withdrawal provisions, and taxation can occur accurately in accordance with qualified retirement plan provisions. These purchases all require movement of funds out of an existing investment and into a purchase of income. In some embodiments, all cases can be treated as a single purchase, and can flow through the same infrastructure as the batch reported purchases starting at the point where purchase data is saved to scratch purchase data 217a by the purchase data API 217, and a notification can be provided to start the purchase process.

In some embodiments, the guaranteed income system and method 10 can process a redemption within the redemption quote API 260 of the annuity process shown in FIG. 2. Following a retirement plan customer 105 to initiating a redemption option 130, the guaranteed income system and method 10 processes and calculates data 132a entering the annuity process 200 as input data 260a. In some embodiments, the guaranteed income system and method 10 can processes and calculate the redemption (process 260b), and calculates surrender charges (process 260c). Further, the redemption quote API 260 can receive income redemption data and record the income redemption to the scratch purchase data 217a using purchase data API 217. In some embodiments, the guaranteed income system and method 10 can enable customers 205, 105 to view the calculated income prior to agreeing to make the purchase. This is referred to as the illustration process.

In some embodiments, either from the participant website or from the guaranteed income system and method 10 contract summary applications, the customer 205, 105 can run income purchase scenarios from an income calculation service provided by guaranteed income system and method 10. This can occur until the customer 205, 105 finds an acceptable income amount. In some embodiments, the customer 205, 105 can then initiate the purchase, and in the case of retirement plan system in-plan purchases, the same details will be provided by the guaranteed income system and method 10 because the batch payroll purchases and retirement plan system can perform the same notification.

In some embodiments, with a customer's selection of the redemption option 130, the guaranteed income system and method 10 can process a redemption with the guaranteed income system and method 10 proceeding with a liquidation process 134 with data 134a entering the annuity process 200 as input data 270a. In some embodiments, the redemption API 270 can include processes for receipt of income redemption data (process 270b), taking into account data 132a (from process 132 discussed above), and a record income redemption 270c. In some embodiments, data from the redemption API 270 can be processed as scratch purchase data 272. Further, in some embodiments, data from the redemption API 270 can be processed by system process API 220. In some embodiments, the system process API 220 can comprise a validate income purchase process 220a, and/or a match money received to income purchase process 220b, and/or an income purchase aggregation process 220c, and/or record income purchase process 220d. In some embodiments, data from the system process 220 can include or comprise retirement income operational data 222 that can process to financial data ETL 224, financial data 226, reserve calculations 228, and financial URL's 230 for a financial analyst 250.

In some embodiments of the invention, the operation of the guaranteed income system and method 10 can be based at least in part on one or more rules or guidelines of a policy (herein referred to a “rider”). In some embodiments of the invention, details of an income purchase rider can be stored by the guaranteed income system and method 10, and those data can be used along with a contract number to record the income purchase. In cases where the income amount is agreed to by the user (such as a customer or participant) prior to purchase, the income amount can be passed to the guaranteed income system and method 10, and stored in the income purchase data. For verification purposes the income amount can be recalculated, and if it matches the income provided, the guaranteed income system and method 10 can then record the purchase to operational data stores.

In some embodiments, recording a scheduled purchase can act much like a single investment transfer where funds will be deducted from existing funded accounts and used as premium for an income purchase. Funds can be extracted from accounts in a variety of ways, and can include withdrawal of funds from existing accounts. Further, in some embodiments, the guaranteed income system and method 10 can generate a calculated model proportional to existing account balances. For example, in some embodiments, an investment transfer can be calculated that can take proportional amounts from existing investment options to purchase guaranteed income.

Referring again to FIG. 1, in some embodiments, the guaranteed income system and method 10 can also include access by a retirement plan sponsor 140 who can provide and/or exchange information comprising a payroll contribution file 142, information from which can be processed by the guaranteed income system and method with contribution passed into the income process API 145 of the annuity process 200. In some embodiments, data 122a from a customer's ongoing pension election can be used as entered data 144a in the contribution transaction process 144. Further, in some embodiments, data 127a from a customer's ongoing pension strategy can be entered as data 144b and output data 144c from the contribution transaction process 144 can enter the income process API 145 of the annuity process 200.

In some embodiments, to facilitate the purchase of the annuity slices, the guaranteed income system and method 10 can be configured to share information back and forth between the retirement plan system (retirement plan process 100) and annuity system (annuity processes 200). Furthermore, the guaranteed income system and method 10 can include a calculation of liquidity on the annuity side, and can transfer liquidity information to the retirement plan system when a participant requests liquidation. In some embodiments, liquidity transfer instructions can occur online or by telephone. Some embodiments include retirement plan system in-plan purchases that can be similar to this on the payroll reporting side. In some embodiments, investment directions (called “splits”) can be applied to contribution amounts, and if an allocation to income purchases is specified, that percentage can be used to calculate the contribution amount (called the “premium”). The retirement plan system will then provide the required purchase details with a notification to apply the payment using an API provided by guaranteed income system and method 10. In some embodiments, this includes, but is not limited to, contribution amount, contract, member id, annuity form, and calculated age. In some embodiments, the guaranteed income system and method 10 can store the data in the purchase data scratch database (scratch purchase data 217a) using the purchase data API 217, and build a request to apply the data to operational stores.

In some embodiments, the guaranteed income system and method 10 can also provide notification in some form to retirement plan system that the request is received and again when the income is recorded (for instance where start or complete workflow processes notification and activity balancing notifications are required). In some embodiments, the guaranteed income system and method 10 can also provide an API that will retrieve purchases according to contract and member ID as well as any other aggregated purchase amounts required.

In the case of retirement plans, the guaranteed income system and method 10 can enable customers to move money back out of income purchases just like an investment transfer out of any other investment option. In those cases, in some embodiments, the amount to be redeemed can be sent to the guaranteed income system and method 10 through an API where the determination can be made to reverse enough income purchases to satisfy the transfer amount. In some embodiments, the methodology for choosing purchases to reverse can comprise LIFO or pro-rata. In some embodiments, in the case of a partial redemption, a new income amount can be calculated using the same assumptions as the original purchase, but with the reduced contribution amount. In some embodiments, the redemptions can trigger a surrender charge according to rules that can be defined as desired.

In some embodiments of the invention, the guaranteed income system and method 10 can assess the surrender charge. In some further embodiments, notifications can be sent when the transfer process is completed by the guaranteed income system and method 10. In some embodiments, the retirement plan system can take that notification and use it to complete the open transfer workflow request.

In some embodiments of the invention, the deferred income annuity can also be offered as part of an asset allocation model. In some embodiments, the asset allocation model can consist of a target date investment option and the deferred income annuity. In some embodiments, models will only use two investment options (deferred income annuity and a target date investment option). Some embodiments of the invention can include an allocation model that would allow 100% investment in the target date investment option until a specific number of years from the target date. At that point, an allocation to deferred income annuity would begin and would increase in size each year until the target date. Further, in some embodiments, there can be a model portfolio for each target date fund (2020, 2025, 2030, etc.) For example, in some embodiments, at 15 years from the target date, the allocation might be 3% to deferred income annuity and 97% to target Date. Each year the allocation to deferred income annuity increases while the allocation to target date decreases. By the year of the target date, the allocation can have increased to 30% to deferred income annuity and 70% to Target Date. A sample embodiment of a 15 year through a retirement “glide path” is shown as follows in Table 2:

TABLE 2
15 year through a retirement “glide path”

| Years to Target Date | Deferred Income Annuity | Target Date Fund |
|---|---|---|
| 16 | 0% | 100% |
| 15 | 3% | 97% |
| 14 | 5% | 95% |
| 13 | 7% | 93% |
| 12 | 9% | 91% |
| 11 | 11% | 89% |
| 10 | 13% | 87% |
| 9 | 15% | 85% |
| 8 | 17% | 83% |
| 7 | 19% | 81% |
| 6 | 21% | 79% |
| 5 | 23% | 77% |
| 4 | 25% | 75% |
| 3 | 27% | 73% |
| 2 | 29% | 71% |
| 1 | 30% | 70% |
| 0 | 30% | 70% |

In some embodiments, as the model portfolio moves through the glide path, there can be annual aging/adjustment of the allocation. In some embodiments, when choosing the allocation model, participants can be informed that rebalancing for the allocation model will be required. Further, in some embodiments, the participant can choose semi-annual or quarterly frequency for the rebalancing. Moreover, in some embodiments, the deferred income annuity product can be restricted from the rebalancing so that there is no requirement for the guaranteed income system and method 10 to divest from a piece of guaranteed income that has already been purchased. However, in some embodiments, additional purchases of deferred income annuity through the rebalancing process can be allowed (“one-way” rebalancing).

Some further embodiments of the invention include the ability to include a deferred income annuity within an asset allocation model with other CIT, separate account and/or mutual fund investment options. In the event of a future regulatory change that allows this type of product to be distributed early from the plan when a plan sponsor moves the retirement plan to a new service provider, or upon the plan sponsor discontinuing offering the product as a plan investment choice for future purchases, in some embodiments, the guaranteed income system and method 10 can allow the annuity certificate to be issued to the participant.

In some embodiments of the invention, the guaranteed income system and method 10 can offer alternative death benefits such as return of premium and commuted value annuities issued to beneficiaries. In some embodiments, after the income payments start, the death benefit will depend on the annuity income option selected.

In other embodiments, the guaranteed income system and method 10 can accommodate a QLAC version and/or an irrevocable version of this deferred income annuity with the capability of having periodic contributions (“annuity by the slice”.)

Some embodiments of the invention include the ability to pair the annuity with a target date investment option in an asset allocation model. Some further embodiments of the invention include the ability to include the annuity within an asset allocation model with other CIT, a separate account, and/or mutual fund investment options. Some embodiments of the invention include the ability to distribute the QLAC deferred annuity certificate to a participant when the participant decides to take a distribution from the plan.

Some other embodiments include the ability to “purchase by the slice” an annuity that is classified as an immediate annuity (due to annuity start date being within 13 months of the purchase of the slice.)

Some embodiments of the invention include the ability for plan sponsors to decide to direct certain plan contributions to the deferred income annuity (or variations of the deferred income annuity). For example, in some embodiments, a plan sponsor can decide to direct an employer profit sharing contribution or matching contribution to the deferred income annuity. (This would not be a participant-directed plan contribution).

In some embodiments, once a participant has taken ownership of the distributed deferred annuity, the guaranteed income system and method 10 can allow future capability for participant to be able to continue making contributions to the annuity.

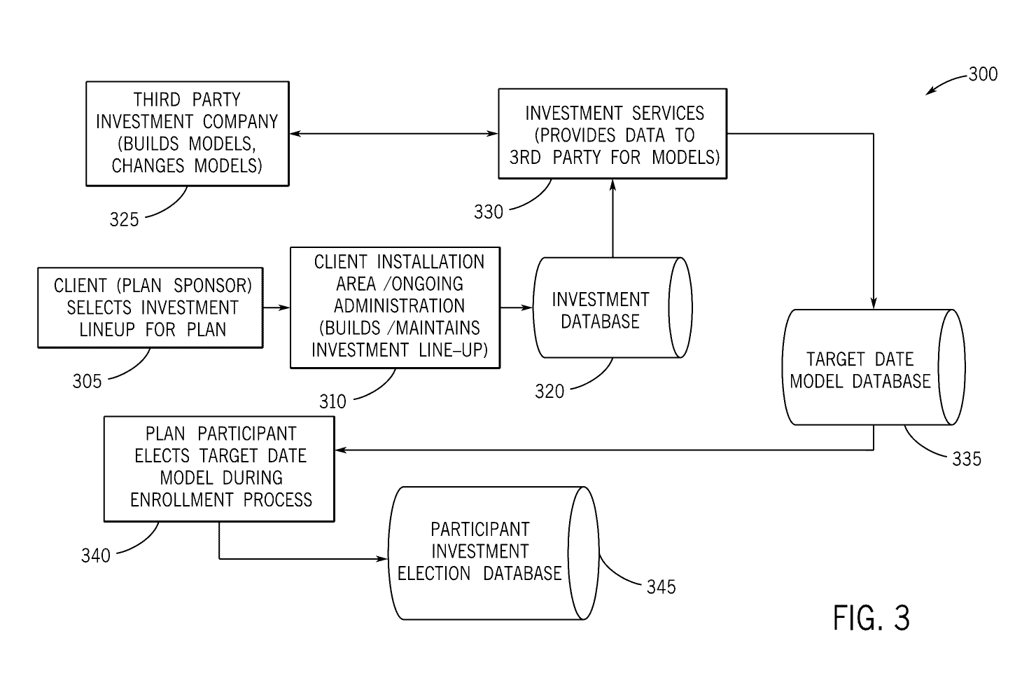

Referring to FIG. 3, illustrating a guaranteed income process system architecture 300, in some embodiments, the guaranteed income system and method 10 can comprise a client, such as a plan sponsor selecting an investment lineup for one or more defined annuity income plans of the guaranteed income system and method 10 (process 305). One or more investment products can be brought into the guaranteed income system and method 10 within a client installation area, and ongoing administration procedures and processes can build and maintain the investment selection (process 310). In some embodiments, investments services can manage a flow of investment data from an investment database (database 320 to investment services 330) to one or more third party investment companies for the purposes of building and maintaining investment models such as target date investment models (process 325). Through this process, one or more target data models (target date model database 335) can be conveyed to a plan participant for election during the enrollment process (process 340), and any selection of a target date investment by a participant can be stored by the guaranteed income system and method 10 (database 345).

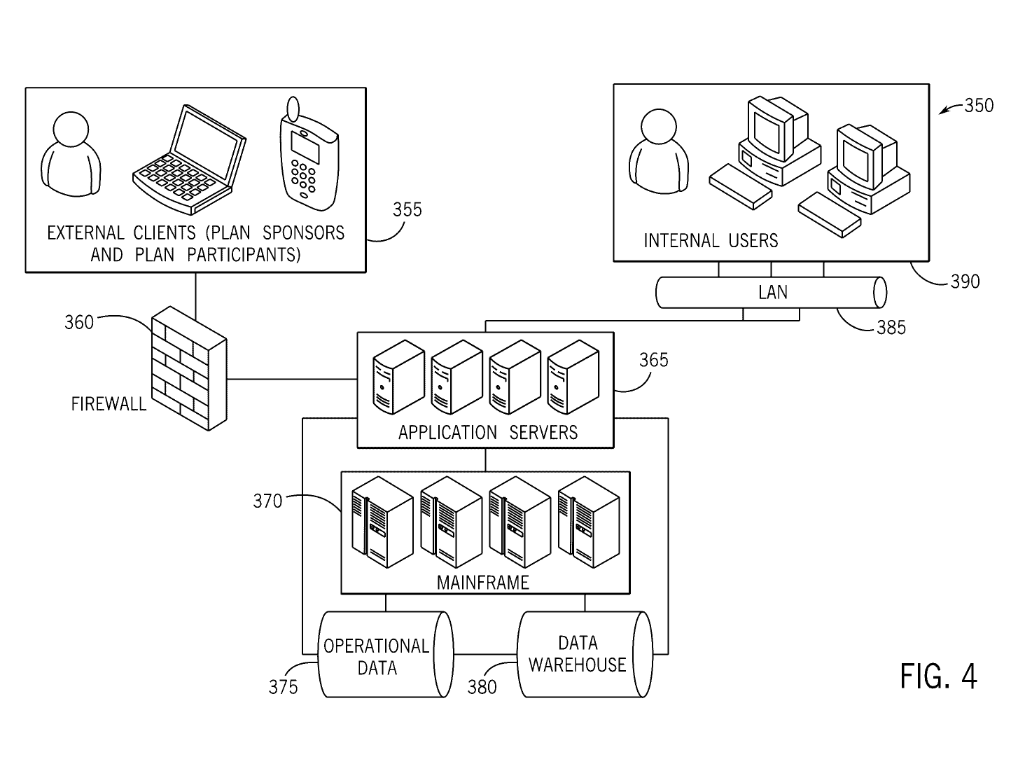

FIG. 4 illustrates an example of a computer system 350 used by the guaranteed income system and method 10 of FIGS. 1-2 in accordance with some embodiments of the invention. FIG. 4 illustrates just one example embodiment of a system that can be used by one or more software modules of the guaranteed income system and method 10 to calculate a guaranteed income product. In some embodiments, the system 350 can facilitate an enrollment of one or more users for the purpose of structuring and/or tailoring a guaranteed income product. Further, in some embodiments, the system 350 can be used to interface with one or more users for the purpose of receiving financial data related to one or more guaranteed income products. For example, in some embodiments, the system 350 can calculate one or more projected annuity income streams based at least in part on financial data and/or preferences provided by a user. In some further embodiments of the invention, the system 350 can include one or more income simulation tools for projection of future retirement income.

In some embodiments of the invention, the system 350 can include at least one computing device 370, including at least one or more processors. In some embodiments, some processors can include processors residing in one or more conventional server platforms 365 that can be coupled to the computing device 370. In some embodiments, the system 365 can include a network interface and an application interface coupled to at least one processor capable of running at least one operating system. In some embodiments, the system 350 can also include at least one computer readable medium. In some embodiments, the at least one computer readable medium can be coupled to at least one data storage device, and/or at least one data source, and/or at least one input/output device. In some embodiments, the computer readable medium can include, but not be limited to, operation data 375 and/or a data warehouse 380 coupled to the computing device 370. In some embodiments, the servers can be coupled to external client or client devices 355 via a firewall 360. In some embodiments, one or more components of the network can include a number of client devices which can be personal computers including for example desktop computers, laptop computers, digital assistants, personal digital assistants, cellular phones, mobile phones, smart phones, pagers, digital tablets, internet appliances, and other processor-based devices. In general, a client device can be any type of external or internal devices such as a mouse, a CD-ROM, DVD, a keyboard, a display, or other input or output devices. In some further embodiments, internal users 390 can coupled to the servers via a local area network (LAN 385).

In some embodiments, the invention can also be embodied as computer readable code on a computer readable medium (e.g., such as operation data 375). In some embodiments, the computer readable medium can be any data storage device that can store data, which can thereafter be read by a computer system. Examples of the computer readable medium can include hard drives, network attached storage, read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor.

In some embodiments, the computer readable medium can also be distributed over a conventional computer network. For example, in some embodiments, the computer readable medium can also be distributed over and/or accessed via the network interface. In this instance, computer readable code can be stored and executed in a distributed fashion using the computer system. For example, in some embodiments, one or more components of the system can be tethered to send and/or receive data through a local area network (“LAN”). In some further embodiments, one or more components of the system can be tethered to send or receive data through an internet (e.g., a wireless internet). In some embodiments, at least one software module running on at least one processor can be configured to be coupled for communication over a network.

In some embodiments, one or more components of the network can include one or more resources for data storage and retrieval. This can include any computer readable media in addition to the computer readable medium, and can be used for facilitating the communication of information from one electronic device to another electronic device. Also, in some embodiments, the network can include wide area networks (“WAN”), direct connections (e.g., through a universal serial bus port), other forms of computer-readable medium, or any combination thereof. In some embodiments, the software modules can be configured to send and receive data from a database (e.g., from at least one computer readable medium including data sources and data storage that can comprise a database such as operational data and/or a data warehouse). Further, in some embodiments, data can be accessed and received by the software modules from at least one other source. In some embodiments, at least one of the software modules can be configured within the system to output data to a user via at least one digital display (e.g., to a computer comprising a digital display). Further, in some embodiments, various other forms of computer-readable medium can transmit or carry instructions to a user interface such as a computer, including a router, private or public network, or other transmission device or channel, both wired and wireless. In some embodiments, the system as described can enable one or more users to receive, analyze, input, modify, create and send data to and from the system, including to and from one or more software modules running on the system. Some embodiments include at least one user 400 accessing one or more modules, including at least one software module via a stationary I/O device through a LAN. In some other embodiments, the system can enable at least one user accessing software module via a stationary or mobile I/O device through an internet.

With the above embodiments in mind, it should be understood that some embodiments of the invention can employ various computer-implemented operations involving data stored in computer systems (such as the system shown in FIG. 4). In addition, in some embodiments, the above-described applications of the monitoring system can be stored on computer-readable storage media (such as computer readable medium). These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Any of the operations described herein that form part of the invention are useful machine operations. The invention also relates to a device or an apparatus for performing these operations. The embodiments of the invention can be defined as a machine that transforms data from one state to another state. The data can represent an article, that can be represented as an electronic signal and electronically manipulate data. The transformed data can, in some cases, be visually rendered onto a display, representing the physical object that results from the transformation of data. The transformed data can be saved to storage generally or in particular formats that enable the construction or depiction of a physical and tangible object. In some embodiments, the manipulation can be performed by one or more processors. In such an example, the processors can transform the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media (such as computer readable medium) as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

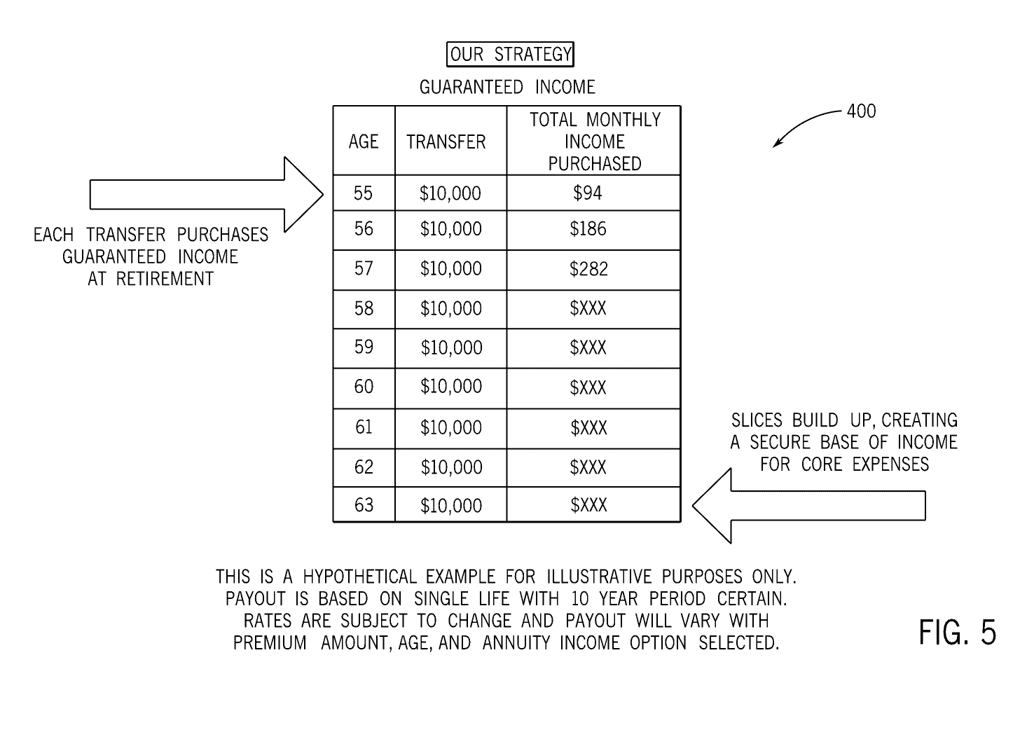

In some embodiments, the guaranteed income system and method 10 can enable a user to build a guaranteed retirement income stream using funds derived from a participant over a period of time. In some embodiments, this guaranteed retirement income stream can be structured to provide a guaranteed income through the life of the participant. FIG. 5 shows a chart 400 illustrating an example of guaranteed income as a function of a plurality of income transfer purchases in accordance with some embodiments of the invention. This example illustrates how a participant can build a stream of guaranteed income by purchasing slices of income over time as mentioned previously. In some embodiments, the amount of income that is purchased with each transaction will vary based on current interest rates and duration of time until the annuity payout date. In some embodiments, annuity payout rates can be higher at younger ages and/or when the time horizon is longer. Further, in some embodiments, annuity payout rates can also be higher when interest rates are higher. Further, to benefit from changing payout rates and to minimize interest rate risk, in some embodiments, the guaranteed income system and method 10 can provide an opportunity for a participant to stagger a plurality of annuity purchases over several years. In effect, this can allow dollar cost averaging of the annuity purchase.

Some embodiments include one or more product packaging options. For example, in some embodiments, the guaranteed income system and method 10 can include a “Stand Alone” model and/or an “Allocation Model” option. In some embodiments, the “Allocation Model” option can include a “glide path” structure. A “glide path” is a representation of how a portfolio is managed over time to become increasingly conservative as it nears a target date. In some embodiments, this can then provide financial structure that includes an allocation to guaranteed income and an allocation to a target date investment option. In some embodiments, the allocation model can be offered for participant election, or as a qualified default investment alternative (“QDIA”). With any of these options, the guaranteed income system and method 10 can be configured to provide participant education, resources and tools to help participants who want to further customize the level of guaranteed income they purchase to match estimated retirement income needs they expect to have in retirement (e.g., such as housing, food, healthcare, travel and leisure).

In some embodiments, the guaranteed income system and method 10 can provide an opportunity for a participant to engage with the “Stand Alone” and/or the “Allocation Model” option by telephone and/or through online access. In some embodiments, online education can assist the participant in understanding the amount of income they may want to purchase. For example, in some embodiments, the guaranteed income system and method 10 can provide questions around risk tolerance, income sources, liquidity needs, and withdrawal expectations. Further, in some embodiments, a similar approach can be used to assist participants in determining investment allocations. For example, some questions help with risk tolerance and allocation models, and others help determine income requirements.

In some embodiments, the participant can view how much income can be purchased based on current rates for the default annuity form and default annuity payment date. Further, in some embodiments, the participant can then speak to an individual trained on the guaranteed income system and method 10) to discuss securing guaranteed income.

In some embodiments of the invention, the participant can also execute the transaction online if they prefer. In some embodiments, the online education can help the participant understand the advantages and disadvantages of purchasing guaranteed income. In some embodiments, questions around risk tolerance, income sources, liquidity needs, and withdrawal expectations can provide education as to whether guaranteed income may align and/or complement the customer's retirement income objectives. In some embodiments, if the participant decides they would like to secure guaranteed income as retirement approaches, they can call a representative of the guaranteed income system and method 10 to speak to a financial professional about an automatic asset allocation that will include guaranteed income. In some embodiments, if the customer 105, 205 prefers to invest in the automatic asset allocation without assistance, they can execute the change online.

Some embodiments include portability of guaranteed income. For example, participants can take the benefit with them if they leave their employer. In this instance, the amount invested in the guaranteed income and promise of the guaranteed monthly income payments stays with the guaranteed income provider. If the plan sponsor chooses another service provider, portability can be provided by a transfer of data that is used for United States Department of Labor Form 5500 and participant reporting. Because there are no ongoing contributions to guaranteed income system and method 10, this information does not need to be updated until a participant has a benefit event and takes a distribution of guaranteed income from the plan, or decides to liquidate guaranteed income.

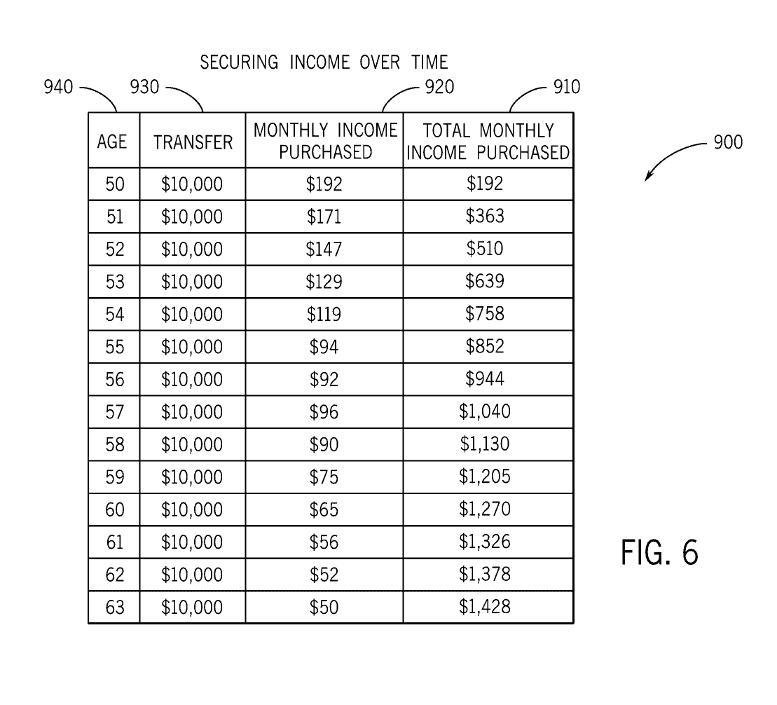

FIG. 6 shows an example guaranteed income data 900 showing total monthly income purchased 910 as a function of a plurality of income transfer purchases (column 920) in accordance with some embodiments of the invention. In these example embodiments, the participant can transfer $10 k of his account balance once per year (e.g., in November) until retirement (represented in column 930), guaranteeing $1,428 of monthly income in retirement. As illustrated, with increasing age and time from the first transfer year (where the participant is age 50 in this example shown in column 940), the monthly income purchased can decrease (e.g., from $192 at age 50 to $96 at age 57, to $50 at age 63). Further, with increasing age and time from the first transfer year, the total accumulated monthly income purchased can rise from the initial amount of $192, to $1040 at age 57, to $1428 at age 63. The amount of monthly guaranteed income purchased varies based on the current interest rates, participant age, and dollars invested.

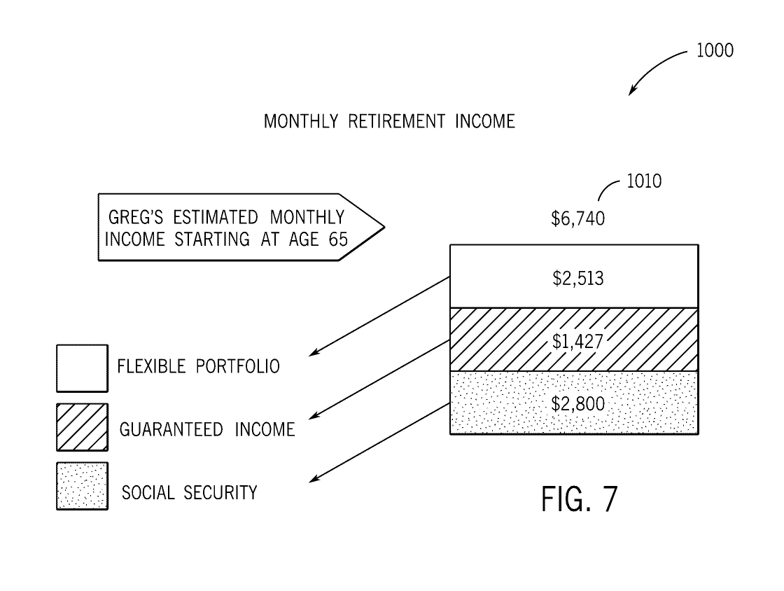

FIG. 7 provides an illustration 1000 of a projection of a monthly retirement income 1010 in accordance with some embodiments of the invention. In some embodiments, the guaranteed income system and method 10 can calculate and display an estimated monthly retirement income 1010 comprising components of a flexible portfolio (remaining account balance not used to purchase guaranteed income), guaranteed income (calculated by the guaranteed income system and method 10), and income derived from social security. In some embodiments, the participant can use the guaranteed income system and method 10 to display total monthly retirement income for any specified retirement age. Further, in some embodiments, the participant can use the guaranteed income system and method 10 to display total monthly retirement income based on one or more annuity purchase slices over a specified period of time.

Some embodiments of the invention include transfers that provide a “free-look” period, so participants can reverse the transaction within 90 days without penalty. In some embodiments, once a purchase is made, the participant can reverse that purchase (return of contribution) with no penalty during the first 90 days. In some embodiments, after 90 days, the purchase may be reversed subject to a possible surrender charge, which depends upon the current interest rate environment versus interest rates at the time the purchase occurred and length of time to income start date. In some embodiments, this surrender charge structure can prevent anti-selection and supports overall income efficiency for the product by having the participants who exercise a surrender of their purchase(s) bear the cost through the surrender charge. Further, surrender charge structure can assist them with a safety net should their circumstances change, and they determine that they no longer want to retain the benefits of the guaranteed income product. In some embodiments, before retirement, participants can move their retirement funds out of the guaranteed income slice. In some embodiments, this move may be subject to a surrender charge.

In some embodiments of the invention, the purchases of one or more slices of guaranteed income (e.g., from one or more defined contribution plans) can include provisions for minimum specific initial investment amount, and a specific subsequent minimum investment amount. In some embodiments, plan participants can direct some of their retirement plan contributions toward the purchase of guaranteed income (a deferred income annuity). This can occur at the frequency and amount they prefer through either a lump sum purchase or through payroll deductions. This is referred to as investing in deferred income annuity as a “stand-alone” investment. In some embodiments of the invention, the guaranteed income system and method 10 can accommodate post tax contributions including Roth purchases, money purchase, employee required contributions, etc.)

Some embodiments include model portfolios comprised of target date and deferred income annuity. This model portfolio could be used as the plan's QDIA. In some embodiments, the target date and deferred income annuity can be offered as stand-alone investments for the plan, and the model portfolio, structured to look like a single investment, can represent education of asset allocation to these investment options.

In some embodiments of the invention, underwriting requirements can limit a participant from investing 100% of their account balance in guaranteed income. For example some embodiments can include a 50% cap on non-model portfolio account balance that can be invested in “stand-alone deferred income annuity” investments. In other embodiments, the cap can be more or less than 50%. Some embodiments can include a dollar cap per participant of $2 million maximum in deferred income annuity contributions. Some embodiments can comprise a guaranteed income product “Qualified Longevity Annuity Contract” (hereinafter QLAC). In this product, the maximum amount a participant may invest can be the lesser of 25% of their account balance or $125,000. In some other embodiments, the maximum amount a participant may invest can be the lesser of more or less than 25% of their account balance.

In some embodiments of the invention, when making an investment transfer into guaranteed income, participants are shown an estimate amount of guaranteed income they will be purchasing prior to the transaction being finalized (for non-recurring lump sum transfers only). This will require that purchase rates be set the day prior at close of business or other times if desired. Participants will also be able to see a history of purchase amounts and income amounts. Actual purchase rates will not be disclosed to participants or plan sponsors in some embodiments.

In some embodiments, a 90 day return of premium window will apply for each contribution into guaranteed income. This feature also meets the QDIA requirement of participants being able to move out of the default investment option within specific number of days of being put into the QDIA (QDIA pertains to the model portfolio). In some embodiments, after the specified number of days, amounts can be moved out of guaranteed income (less return of premium or premium subject to an early withdrawal charge). In some embodiments, these negative charges can be calculated based on United State treasury rates and/or an industry mortality table. In some embodiments, the specified period can be 90 days. In other embodiments, the specified period can be more or less than 90 days. In some other embodiments, the premium window can be more or less than 90 days.

In some embodiments, a 12-month roundtrip restriction will be applied to individuals who choose to liquidate part or all of the deferred income annuity. In some embodiments, the restriction will be applied to investment transfers only, and not to ongoing payroll contributions.

In some embodiments of the invention, the rider can constitute a guaranteed benefit policy as defined in section 401(b)(2)(b) of ERISA and any regulations promulgated thereunder. As described earlier, details of the rider can be stored by the guaranteed income system and method 10. In some embodiments of the invention, the guaranteed income system and method 10 can apply at least one rule or guideline to each contribution directed to the guaranteed income option. For example, in some embodiments, each contribution can be applied to purchase a paid-up deferred annuity that can provide a specific dollar amount of guaranteed income (based on an assumed form of a single life annuity with a ten year certain period) with payments beginning on the default income start date, subject certain provisions defined herein. By directing contributions to the guaranteed income option, participants agree that the paid-up deferred annuities not surrendered can be distributed from the plan as a certificate prior to the participant's income start date, if not previously distributed to the participant in the form of a deferred annuity certificate. Further, an annuity purchase certificate can be provided to the participant when the initial contribution is directed to the guaranteed income option.

In some embodiments of the invention, each contribution can be applied to purchase a paid-up deferred annuity for the specified participant as of the business day on which the guaranteed income system and method 10 can accept the contribution. In some embodiments, the amount of a contribution that is a transfer from another plan investment option can be generally determined and transferred within seven business days from the date the guaranteed income system and method 10 receives the transfer request, subject to the terms and conditions of that other investment option.

In some embodiments of the invention, the minimum amount for contributions that are transfers from another plan investment option to the guaranteed income option to purchase paid-up deferred annuities for a participant at any one time can be $10. In some other embodiments, the minimum amount for contributions can be more or less than $10. In some embodiments, there is no minimum amount for any other types of contributions directed to the guaranteed income option. In some embodiments, participants can direct up to 50% of their contributions as defined in the document to the guaranteed income option. In some other embodiments, the contributions can be more or less than 50%.

In some embodiments of the invention, the guaranteed income balance for a participant can be up to $2,000,000. In some other embodiments, the income balance for a participant can more or less than $2,000,000. In some embodiments, contributions that would cause the guaranteed income balance for a participant to exceed $2,000,000 can be limited. In some embodiments, any such excess contributions can be transferred to the investment option that is used when a contribution is received for a participant for whom no notification of investment direction is on file with the guaranteed system and method, as selected by the participant. Additionally, in some embodiments, if the participant's guaranteed income balance exceeds a limit of 50% of the participant's total account value in the plan, net of outstanding loan balances, contributions that are transfers from another plan investment option to the guaranteed income option can be limited. In other embodiments, the limit can be more or less than 50%.

In some embodiments of the invention, a contribution may not be directed to the guaranteed income option to purchase a paid-up deferred annuity for a participant within sixty days of a participant's income start date. In other embodiments, the number of days can be more or less than sixty days. Further, in some embodiments, any such contribution directed to the guaranteed income option can be transferred to the investment option that is used when a contribution is received for a participant for whom no notification of investment direction is on file with us, as selected by the organization.

In some embodiments of the invention, a paid-up deferred annuity can be purchased using current purchase rates. In some embodiments of the invention, minimum incomes for purchases made within the five-year period beginning Jan. 1, 2000, can be 97% of the incomes purchased under the above basis. In some embodiments, minimum incomes for purchases made within any subsequent five year period can be 97% of the incomes for the preceding five-year period. In other embodiments, the minimum incomes can be more or less than 97% of the incomes for the preceding five-year period.

In some embodiments, the guaranteed income system and method 10 can amend or change the paid-up deferred annuity purchase rate. For example, in some embodiments, the basis can be modified on any date which is later than (i) five years after the effective date of the rider or (ii) five years after the latest date of amendment to, or change of rate. In other embodiments, the period can be more or less than five years.

In some embodiments, for contributions received after the effective date of the latest amendment or change, the latest amended paid-up deferred annuity purchase basis will apply. In some embodiments, the guaranteed income system and method 10 can announce any such amendment or change at least sixty days before it will take effect. In other embodiments, the period can be more or less than sixty days.

In some embodiments, at the time a paid-up deferred annuity is purchased, the amount of the paid-up deferred annuity benefit purchased will not be less than the greater of (i) the amount that could be purchased by applying the contribution to the purchase rates described above, or (ii) the amount that could be purchased by applying the contribution to a guaranteed paid up deferred annuity contract which guaranteed income system and method 10 can make available to participants of this class.

In some embodiments, the guaranteed income system and method 10 can enable a participant surrender of a paid-up deferred annuity. For example, in some embodiments, a participant can elect to surrender all or a portion of a paid-up deferred annuity and receive the surrender value of such paid-up deferred annuity. In such instance, paid-up deferred annuities can be surrendered starting with the most recently purchased paid-up deferred annuity, and then each preceding purchased paid-up deferred annuity, with the oldest purchased paid-up deferred annuity being surrendered last. Further, the guaranteed income system and method 10 can transfer the surrender value to another plan investment option, as directed by the participant, subject to the terms and conditions of that plan investment option. Further, prior to surrender of all or a portion of a paid-up deferred annuity, the guaranteed income system and method 10 can announce to the participant the surrender charge for such surrender, following the election to surrender and in advance of any surrender.

In some embodiments, a participant may not elect to surrender all or a portion of a paid-up deferred annuity within sixty days of such participant's income start date. In some other embodiments, the time period can be more or less than sixty days. In some embodiments, if all or a portion of a paid-up deferred annuity is surrendered (other than one that has been distributed in the form of a deferred annuity certificate) by a participant, that participant may not make a contribution that is a transfer from another investment option to the guaranteed income option for twelve months. In some other embodiments, the time period can be greater than or less than twelve months.

In some embodiments of the invention, a participant who has received a distribution from the plan of all of his paid-up deferred annuities in the form of a deferred annuity certificate may surrender all or a portion of his paid-up deferred annuities. However, in some embodiments, if the surrender under such deferred annuity certificate would result in a remaining guaranteed income balance of $5,000 or less, the total guaranteed income balance under such deferred annuity certificate can be surrendered. In some other embodiments, the balance limit can be greater than $5000. In some embodiments, a participant may not elect to surrender all of his paid-up deferred annuities within sixty days of such participant's income start date. In some other embodiments, the time period can be more than sixty days.

In some embodiments, the rider can include rules or guidelines for guaranteed income payments. For example, in some embodiments, the guaranteed income system and method 10 can calculate guaranteed income payments at the time each paid-up deferred annuity is purchased, based on an annuity form of a single life annuity with a ten year certain period with monthly payments beginning on the default income start date. In some embodiments, if not previously distributed from the plan in the form of a deferred annuity certificate, all of a participant's paid-up deferred annuities can be distributed from the plan by the issuance of a certificate, and a participant's final elections can be reflected in such certificate.

In some embodiments of the invention, no guaranteed income payments can be made if the vested value of the guaranteed income balance for a participant is less than or equal to a set limit (e.g., $5,000). In some embodiments, if the vested value of the guaranteed income balance for a participant is less than or equal to $5,000 at sixty days prior to the income start date, the guaranteed system and method can surrender all of the paid-up deferred annuities and, unless otherwise agreed upon between the organizations, an allocation of the small amount surrender value to the investment option will be made that is used when a contribution is received for a participant for whom no notification of investment direction is on file with the guaranteed income system and method 10, as selected by the organization. In other embodiments, the set limit can be more than $5,000. In some embodiments of the invention, no contributions, surrenders, annuity form changes, or contingent annuitant changes may be made by a participant during the sixty days preceding the income start date or after the income start date. However, in some embodiments, the guaranteed income system and method 10 may make annuity form changes as directed by the rider. In other embodiments, the sixty day period can be reduced to less than sixty days, or raised to more than sixty days.

In some embodiments, the rider can include rules or guidelines for income start date changes. For example, in some embodiments, the income start date for a participant with a guaranteed income balance can be a default income start date except as otherwise described below in “first purchase near or after default income start date”. Further, at the earlier of (i) experiencing a separation of service and attaining age 59, or (ii) 180 days prior to attaining normal retirement date without experiencing a separation of service, a participant may make a one-time irrevocable election to change the income start date from the default income start date. In some other embodiments, the age can be lower than 59 or higher than 59, and/or the time can be less than or more than 180 days.

In some embodiments, if a participant's income start date has been changed, future paid-up deferred annuity purchases can be based on the new income start date rather than the default income start date. In some embodiments, in the “approaching normal retirement date” section, a participant changes his income start date to correspond with his expected future separation of service and such participant has attained age 65 and one day, future paid-up deferred annuity purchases can be based on income starting on his current age at the time of such purchases plus two years. In some embodiments, this income starting age assumption will increase by one year annually on the day following his birthday until the participant attains age 69 and one day. Further, once a participant attains age 69 and one day, future paid-up deferred annuity purchases can be based on income starting on the date the participant attains age 71. In other embodiments, the specific age ranges can vary from those described.

In some embodiments, after separation of service except as described below in “first purchase near or after default income start date”, a participant who experiences a separation of service, has attained age 59, and has made a contribution to the guaranteed income option, may make a one-time irrevocable election to change the income start date. Further, in some embodiments, the income start date can be changed to a date when such participant is between age 59½ and April 1 following the year in which the participant attains age 70½. In other embodiments, the specific age ranges can vary from those described.

In some embodiments, once a participant attains age 59, and the guaranteed income system and method 10 has been notified that such participant has experienced a separation of service, and further that the participant has made a contribution to the guaranteed income option, the guaranteed income system and method 10 can announce to the participant the ability to elect a different income start date within the applicable election time period. In some embodiments, if no income start date election is made within the election time period, guaranteed income payments can begin on the participant's default income start date.

In some embodiments, except as described below in the “first purchase near or after default income start date” section, a participant who is approaching his normal retirement date but has not experienced a separation of service may make a one-time irrevocable election to change the income start date as described below. In some embodiments, 180 days prior to a participant's normal retirement date, the guaranteed income system and method 10 will announce to the participant his ability to elect a different income start date within his election time period. In some embodiments, if no income start date election is made within the election time period, guaranteed income payments can begin on the participant's default income start date.

In some embodiments, a participant can select an income start date that is between ages 59½ and April 1 following the year in which the participant attains age 70½. In some further embodiments, a participant can make a one-time election to have his income start date correspond with his separation of service, but in no event will the income start date be later than April 1 following the year in which the participant attains age 70½. Further, in some embodiments, if a participant has elected to have his income start date correspond with his separation of service, once the guaranteed income system and method 10 has been notified by the organization of his separation of service or as of 180 days prior to April 1 following the year in which the participant attains age 70½, if earlier, the guaranteed income system and method 10 can announce to the participant the option to elect an income start date and annuity form. Further, in some embodiments, the elected income start date may not be later than the earlier of 180 days after the guaranteed income system and method 10 are notified of his separation of service or April 1 following the year in which the participant attains age 70½. In some embodiments, if no income start date election is made within the election time period, guaranteed income payments can begin the earlier of 180 days after the guaranteed income system and method 10 is notified of the participant's separation of service or April 1 following the year in which the participant attains age 70½.

In some embodiments, if the participant's first paid-up deferred annuity purchase occurs on or after the date which is 180 days prior to the default income start date, purchases can be based on income starting on the participant's current age at the time of first purchase plus two years. However, in some embodiments, in no event can purchases be based on income starting later than the date the participant attains age 71. In some embodiments, after the first purchase, the guaranteed income system and method 10 can announce to such participant the ability to irrevocably elect an income start date within the applicable election time period. In some embodiments, income start date choices in the “after separation of service” or “approaching normal retirement date” sections, as applicable.

In some embodiments of the invention, if the participant has not separated from service and makes no income start date election within the election time period, paid-up deferred annuity purchases and guaranteed income payments can be administered as if the participant had elected to change his income start date to correspond with his expected future separation of service as described above in “approaching normal retirement date”.

In some further embodiments of the invention, if the participant has experienced a separation of service prior to the first paid-up deferred annuity purchase, and no income start date election is made within the election time period, paid-up deferred annuity purchases and guaranteed income payments can continue to be administered with an income start date of the participant's current age at the time of the first purchase plus two years. However, in some embodiments, in no event can purchases be based on income starting after the date the participant attains age 71.

In some embodiments of the invention, a participant must elect a single form of annuity for all paid-up deferred annuities, which may include optional cost of living adjustment features described below. In some embodiments, when the guaranteed income system and method 10 announces to a participant the ability to elect his income start date, the guaranteed income system and method 10 can also announce to the participant the requirement to irrevocably elect a form of annuity, ability to add a cost of living adjustment feature, and ability to receive annuity payments less frequently than monthly. In some embodiments, if the participant elects an income start date more than 180 days in the future, the guaranteed income system and method 10 can again announce to the participant the requirement to elect a form of annuity 180 days prior to his income start date. In some embodiments, the participant may elect an alternative form of annuity up to sixty days prior to the income start date.

In some embodiments, if no annuity form election is made as of sixty days prior to the income start date, the annuity form will be changed to a 50% joint and survivor annuity, based on the assumption that the participant's spouse, who is the assumed contingent annuitant, is three years younger than the participant.

In some embodiments of the invention, if the participant later provides evidence of the participant's spouse's actual age, the amounts of the guaranteed income payments payable by the guaranteed income system and method 10 can be modified on the basis of the correct age of the participant's spouse. In some embodiments, if the participant provides a notice that the participant was unmarried on the income start date, the guaranteed income payments can be modified using the single life with a ten year certain period annuity form. In some embodiments, any overpayment by the guaranteed income system and method 10 resulting from an incorrect age of the participant's spouse can be deducted from amounts thereafter payable to the participant or the participant's designated beneficiary. Further, in some embodiments, any underpayment by the guaranteed income system and method 10 resulting from an incorrect age of the participant's spouse or from using the 50% joint & survivor annuity form for an unmarried participant can be paid in full with the next payment due the participant or the participant's designated beneficiary. Further, in the event of any changes to the age of a participant's spouse or a participant's marital status as outlined above, the participant can be responsible for any impacts to the calculation of a required minimum distribution in accordance with the requirements under treasury regulation section. In some embodiments, the guaranteed income system and method 10 can communicate to the participant and the participant's spouse a written explanation that would satisfy the notice requirements of code section 417(a)(3) and treasury regulation section 1.417(a)(3)-1. Further, the consent of the participant to a benefit that is immediately distributable can be made after the date the participant is provided with the notice of the ability to defer the distribution, and such consent can be in writing. Further, spousal consent can be required if the form of annuity elected by the participant is not a joint and survivor annuity with the spouse designated as the contingent annuitant. Further, in some embodiments, neither the consent of the participant nor the participant's spouse shall be required to the extent that a distribution is required to satisfy code sections 401(a)(9) or 415. Further, the annuity form and, if elected, any optional cost of living adjustment feature, will comply with Internal Revenue Service required minimum distribution rules under code section 401(a)(9). In some embodiments, in the event the plan's provisions require the calculation of a required minimum distribution in accordance with the requirements under treasury regulation section [1.401(a)(9)-5], if the guaranteed income payments have not already commenced and amounts held in the plan's investment options other than the guaranteed income option are insufficient to cover the required minimum distribution, the required minimum distribution shall be determined in accordance with the requirements under treasury regulation section [1.401(a)(9)-6].

In some embodiments, if a participant elects one of the following optional cost of living adjustment features, this election can apply to all current and prospective purchased paid-up deferred annuities with regard to that participant and cannot be changed. In some embodiments, these features can allow for potential increases to the guaranteed income payment amounts a participant receives after the income start date. Further, in some embodiments, the election of either of these features will result in a lower guaranteed income payment in the early years following the income start date that guaranteed income payments are made than if the participant had not elected the feature.

In some embodiments, a participant can elect a guaranteed income payment adjustment based on a fixed percentage. In some embodiments, the fixed percentage on which the adjustment can be based can be elected by the participant, and can be a whole percent ranging from about one to about five percent. In some embodiments, once elected, the fixed percentage is set and may not be changed. In some embodiments, if a participant elects this feature, on each anniversary of the income start date, the guaranteed income payment can increase by the fixed percentage elected. Further, on each anniversary of the income start date, the guaranteed income payment for that year can equal the prior year's guaranteed income payment multiplied by (one plus the fixed percentage).

In some embodiments, the rider can include rules or guidelines for adjustments to income. In some embodiments, guaranteed income payment amounts are based on monthly payments beginning on the default income start date in the form of a single life annuity with a ten year certain period. In some embodiments, changes can modify the guaranteed income payment amounts originally communicated to a participant including: a) income start date (a change to an earlier date will result in a decrease to guaranteed income payment amounts while a change to a later date will result in an increase in guaranteed income payment amounts), and b) annuity form, including changes as a result of the assumed or corrected marital status (for example, an election of a joint and survivor annuity will result in lower guaranteed income payment amounts than a single life annuity with a ten year certain period), and c) annuity payment frequency (a change to less frequent annuity payments will result in an increase to guaranteed income payment amounts), and d) age of a participant's spouse (for example, if the spouse is younger than the age assumed, the guaranteed income payment amounts can be lower).

In some embodiments, the modified guaranteed income payment amounts reflecting any of the changes listed above can be determined as of the income start date, using the participant's then current age, as the actuarial equivalent of the original guaranteed income payment amounts reflecting the characteristics used for the original purchase as described above. In some embodiments, the basis for determining the actuarial equivalent shall be the 2012 individual annuity reserving table, and the original interest rate used to determine the amount of guaranteed income payments for each contribution to the guaranteed income option.

In some embodiments of the invention, the rider can include rules or guidelines for death benefits. For example, in some embodiments, if a participant dies prior to commencing annuity payments under the guaranteed income option, and the paid-up deferred annuities have not previously been distributed to the participant in the form of a deferred annuity certificate, the death benefit can be the vested amount of the guaranteed income balance, and can be distributed as provided under the plan. In some embodiments, when no distribution has been elected, the vested amount of the guaranteed income balance can be transferred to the investment option that is used when a contribution is received for a participant for whom no notification of investment direction is on file with the guaranteed income system and method, as selected by the organization. In some embodiments, this payment or transfer can satisfy obligations in regards to the participant and designated beneficiary under the rider.

In some embodiments, if the designated beneficiary is the participant's spouse and the spouse does not make an election within sixty days as outlined above, the provisions of the above two paragraphs can apply.

In some embodiments, if the paid-up deferred annuities have previously been distributed to the participant in the form of a deferred annuity certificate, the death benefit can be the vested amount of the guaranteed income balance, and can be paid to the designated beneficiary. In some embodiments, this payment or transfer will satisfy the organization's obligations in regards to the participant and designated beneficiary under this rider. In some embodiments, if the designated beneficiary is the participant's spouse, the guaranteed income system and method 10 can announce to the spouse the ability to elect to have a guaranteed income balance created in the spouse's name equal to the vested amount of the guaranteed income balance of the participant as of the date of the participant's death, and the spouse shall have sixty days from the date the organization's announcement to make such an election.

In some embodiments of the invention, upon the establishment of the guaranteed income balance for the spouse as the designated beneficiary, the spouse can have the same rights, and be subject to the same limitations as a participant. In some embodiments, the income start date for such spouse can be age 65 unless changed. However, in some embodiments, the spouse's income start date may not be earlier than the date the spouse turns 59½ or later than the April 1 following the year when the participant would have attained age 70½. In some embodiments, the guaranteed income payments can be adjusted based on the age of the spouse. In some embodiments, the spouse's guaranteed income payment can be the actuarial equivalent of the participant's guaranteed income payment. In some embodiments, the basis for determining the actuarial equivalent shall be the age of the spouse, the income start date, the 2012 individual annuity reserving table, and the interest rate used to determine the amount of guaranteed income payments for each contribution to the guaranteed income option. Further, in some embodiments, an annuity purchase certificate or deferred annuity certificate can be provided as applicable to the spouse.

In some embodiments of the invention, the rider can include rules or guidelines for transfers from the guaranteed income option. For example, in some embodiments, any transfer from the guaranteed income option can proceed following a surrender event, and the amount can be the surrender value of the paid-up deferred annuity surrendered pursuant to the notice directing such surrender and transfer. In some embodiments, if that requested amount is a stated dollar amount, then to the extent the value of the guaranteed income balance is sufficient, the guaranteed income system and method 10 can transfer or pay such amount. In some embodiments, if the notice directs that a percentage of a value of a guaranteed income balance is to be transferred or paid, then the amount to be so transferred or paid can be that stated percentage of the value of the applicable guaranteed income balance as of the day before the day on which the transfer or payment is to be made. In some embodiments, prior to surrender of all or a portion of a paid-up deferred annuity, the guaranteed income system and method 10 can announce to the participant the surrender charge for such surrender.

In some embodiments of the invention, a transfer from a participant's interest in the guaranteed income option to a separate account available to the plan under the document can occur on a valuation date, as defined in any rider providing access to separate accounts. Further, in some embodiments, any transfer can be deducted from the participant's guaranteed income balance as of the date of transfer.

In some embodiments, if fees are to be deducted from the guaranteed income option, portions of paid-up deferred annuities with regard to all participants with guaranteed income balances can be surrendered to provide an amount equal to such fees. Further, in some embodiments, surrenders can be, with regard to each affected participant, from the paid-up deferred annuity most recently purchased first, then from each preceding purchased paid-up deferred annuity, with the oldest purchased paid-up deferred annuity being last applied.

In some embodiments, if surrenders are required in order to meet the nondiscrimination requirements under code sections 401(k) or (m) or the plan contribution limitation requirements under code section 415, or if any surrender is required by the plan due to events such as a mistake of fact refund or true-up allocation, restrictions on transfers from the guaranteed income option shall not apply.

In some embodiments, if additional amounts are contributed, those amounts can be used to purchase paid-up deferred annuities with regard to participant clients identify to the guaranteed income system and method 10. Further, in some embodiments, such purchases can be treated as if directed by the appropriate participants.

In some embodiments of the invention, prior to the income start date and subject to the provisions of the plan, if a participant is entitled to take a plan distribution, in-service withdrawal, hardship withdrawal, or loan from the guaranteed income option, the following provisions will apply: 1) upon requesting a plan distribution, if the value of a participant's vested portion of the guaranteed income balance is greater than a specified amount (e.g., such as $5,000), all of the paid-up deferred annuities purchased for that participant can be distributed from the plan in the form of a deferred annuity certificate. Further, if the total value of such participant's vested guaranteed income balance is less than or equal to $5,000, the guaranteed income system and method 10 can surrender the participant's paid-up deferred annuities and distribute the small amount surrender value, and 2) if the participant is subject to the small amounts force-out distribution provisions of the plan, the guaranteed income system and method 10 can surrender all of the participant's paid-up deferred annuities, and transfer the vested portion of the small amount surrender value in accordance with the regulations concerning small amount force-outs, and 3) a participant may request his entire interest in the guaranteed income option be distributed as a deferred annuity certificate as part of an in-service withdrawal (excluding hardship withdrawals) from the plan if the participant's vested guaranteed income balance is greater than $5,000. Further, a participant can also elect to surrender all or a portion of the paid-up deferred annuity, and transfer the surrender value to a different investment option available under the plan prior to requesting the in-service withdrawal. Further, prior to surrender of all or a portion of a paid-up deferred annuity, the guaranteed income system and method 10 can announce to the participant the surrender charge for such surrender.

In some embodiments, the paid-up deferred annuities cannot be distributed as a deferred annuity certificate as part of proceeds for a hardship withdrawal or loan under the plan. In this instance, a participant may elect to surrender all or a portion of the paid-up deferred annuities and transfer the surrender value to a different investment option available under the plan prior to requesting the hardship withdrawal or loan. Further, prior to surrender of all or a portion of a paid-up deferred annuity, the guaranteed income system and method 10 can announce to the participant the surrender charge for such surrender.

In some embodiments, in the event a participant's paid-up deferred annuities are affected by a qualified domestic relations order (hereinafter “QDRO”), the QDRO is received prior to the income start date, the participant's interest in the guaranteed income option can be adjusted as applicable under the QDRO and applicable law. In some embodiments, if consistent with the QDRO and applicable law, a guaranteed income balance can be created for the alternate payee and paid-up deferred annuities purchased with respect to the participant can be assigned from the participant to the alternate payee named in the QDRO, the alternate payee will have the same rights, and be subject to the same limitations, as a participant, including the ability to surrender the guaranteed income balance.

In some embodiments of the invention, paid-up deferred annuities assigned to the alternate payee can be adjusted to reflect the alternate payee's relevant data, such as the age of the alternate payee. In some embodiments, the alternate payee's paid-up deferred annuities can be determined as of the date the guaranteed income balance is created for the alternate payee as the actuarial equivalent of those assigned from the participant by the QDRO. In some embodiments, the basis for determining the actuarial equivalent shall be the age of the alternate payee, the income start date, the 2012 individual annuity reserving table, or other individual annuity reserving table from a date before or after 2012, and the interest rate used to determine the amount of guaranteed income payments for each contribution to the guaranteed income option. In some embodiments, the income start date for such alternate payee can be age 65. However, in some embodiments, the alternate payee's income start date may not be earlier than the date the participant turns 59½ or later than the April 1 following the year when the participant would have attained age 70½. In some embodiments, deferred annuity certificate or annuity purchase certificate can be provided as applicable to the alternate payee. In the event a participant's guaranteed income payments are impacted by a QDRO or such other order, benefits guaranteed under this rider can be paid as set forth in such order.

In some embodiments of the invention, the rider can include rules or guidelines for transfers on surrenders and transfers from the guaranteed income option. For example, in some embodiments, in general, surrenders and transfers of the proceeds of surrender of a participant's interest in the guaranteed income option can be made in full within seven business days of receipt of notification directing the surrender and transfer. However, in some embodiments, the guaranteed income system and method 10 can reserve the right to defer any surrender or transfer under this rider up to 180 days. In some embodiments, these delay rights will not apply to a surrender for payments to the designated beneficiary named by the participant or for payments to a participant due to disability or retirement under the plan. In some embodiments, such deferment can be based on unstable or disorderly market or investment conditions which does not allow for an orderly investment transfer. In some embodiments, this deferment may include, but not be limited to, situations where regular banking has been suspended or when an emergency or other circumstances beyond the organization's control do not allow for the orderly disposal and liquidation of securities or other assets.

In some embodiments of the invention, if guaranteed income system and method 10 receives a notice directing the organization to surrender all or a portion of a paid-up deferred annuity with regard to a participant, the guaranteed income system and method 10 reserves the right to pay or transfer the resulting surrender value as set forth in this paragraph. In some embodiments, this paragraph affects only the amount, if any, by which the resulting surrender value, when added to the amount of surrender value payments or transfers made with respect to all participants in the twelve months prior to the organization's receipt of the requested surrender, is in excess of the greater of the following (“excess amount”): 1) 25% of the aggregate value of the guaranteed income balances under this rider on the date twelve months prior to such determination date, or 2) $25,000,000, guaranteed income system and method 10 will pay or transfer the excess amount in substantially equal monthly installments over a period not to exceed 36 months. In some embodiments, for purposes of the limitation on the excess amount in this paragraph, liquidations and transfers at investment value from the organization's general account from any other documents, contracts, or policies in connection with the plan or any other retirement plan of the employer can be included as surrenders or transfers from the guaranteed income balances under this document. Further, in some embodiments, a notice to surrender multiple paid-up deferred annuities can be treated as a series of notices to surrender each affected paid-up deferred annuity; however, the amounts in question can be aggregated for the purposes of comparison to 1) and 2) of this paragraph. In some embodiments, if this limitation is imposed, guaranteed income system and method 10 will make the first installment one month after the date of request, or on the date specified in a notification.

In some embodiments of the invention, upon mutual agreement between the organizations, paid-up deferred annuities and their associated guaranteed income balances for participants can be transferred to another substantially similar contract issued by the guaranteed income system and method 10. The guaranteed income system and method 10 can prepare and send individual annuity purchase certificates and deferred annuity certificates to each participant whose paid-up deferred annuities are transferred to another contract issued by guaranteed income system and method 10.

In some embodiments of the invention, a participant's vested percentage based upon the plan's vesting schedule, if any, can be applied to each paid-up deferred annuity purchase. Further, any non-vested portions of a participant's paid-up deferred annuities can be reflected in the guaranteed income balance along with the vested portions. However, in some embodiments, if a forfeiture event occurs with regard to a participant, the non-vested portion of the paid-up deferred annuity can be surrendered. In some embodiments, the amount surrendered can be the amount used to purchase the surrendered portion of the paid-up deferred annuity and can be transferred in accordance with plan provisions regarding forfeitures on the earliest possible date after the forfeiture.

In some embodiments, if the plan recordkeeper changes, or the guaranteed income system and method 10 is notified to terminate the document, the guaranteed income system and method 10 can no longer accept contributions to the guaranteed income option, and paid-up deferred annuities will continue.

In some embodiments, if the total value of a participant's guaranteed income balance is less than or equal to $5,000, the guaranteed income system and method 10 can surrender that participant's paid-up deferred annuities and transfer the small amount surrender value, unless otherwise agreed upon between the organizations to the plan investment option that is used when a contribution is received for a participant for whom no notification of investment direction is on file with the guaranteed income system and method 10, as selected by the organization. In some embodiments, if the total value of the guaranteed income balance for a participant is greater than $5,000, the guaranteed income balance can remain, and the paid-up deferred annuities with regard to that participant can continue. Alternatively, in some embodiments, if the guaranteed income system and method 10 is directed to surrender the paid-up deferred annuities, the paid-up deferred annuities can be surrendered and payment of the aggregate surrender value of all of the paid-up deferred annuities can be transferred to another funding agent. Further, in some embodiments, paid-up deferred annuities that have been distributed from the plan in the form of deferred annuity certificates may be surrendered. In some embodiments, the surrender value can be determined and transferred within seven business days after the date the guaranteed income system and method 10 receives notification. In some embodiments, if a payment request is made at a later date, the amounts to be paid out can be determined and paid as of that date. Further, in some embodiments, the guaranteed income system and method 10 can announce to the participants the surrender charge for such surrender.

In some embodiments, once the guaranteed income system and method 10 is notified of a desire to change record-keepers or terminate the document, the guaranteed income system and method 10 can announce when the guaranteed income system and method 10 will stop accepting contributions to the guaranteed income option. In some embodiments, once the guaranteed income system and method 10 is notified of a desire to terminate the guaranteed income option as a document option, the guaranteed income system and method 10 can, on the date provided by the organization in the notice, cease to accept future contributions, and can allow the purchase of any more paid-up deferred annuities. In some embodiments, all paid-up deferred annuities in effect at the time that guaranteed income system and method 10 cease to accept contributions or allow the purchase of paid-up deferred annuities will remain in effect unless surrendered (i) by the relevant participant, (ii) due to the small amount surrender value as noted in this section p, or (iii) by the organization.

In some embodiments, upon notification to the guaranteed income system and method 10, the organization can direct the guaranteed income system and method 10 to surrender the paid-up deferred annuities. In some embodiments, the guaranteed income system and method 10 can allocate the surrender value for each participant to the investment option that is used when a contribution is received for a participant for whom no notification of investment direction is on file with the guaranteed income system and method 10, as selected by the organization. The guaranteed income system and method 10 can announce to the participants the surrender charge for such surrender.

In some embodiments, if, at the time that the guaranteed income system and method 10 ceases to accept contributions or allow the purchase of paid-up deferred annuities, the total value of a participant's guaranteed income balance is less than or equal to $5,000, the guaranteed income system and method 10 can surrender that participant's paid-up deferred annuities and transfer the small amount surrender value to the plan investment option that is used when a contribution is received for a participant for whom no notification of investment direction is on file. Further, in some embodiments, if the total value of the guaranteed income balance for a participant is greater than $5,000, the guaranteed income balance can remain and the paid-up deferred annuities with regard to that participant can continue.

In some embodiments, no contributions to the guaranteed income option can be allowed once it has been terminated. In some embodiments, the guaranteed income option may not be added for twelve months after it has been terminated as a document option.

In some embodiments of the invention, notification to the guaranteed income system and method 10 of termination of the plan can be treated as notice to terminate the guaranteed income option. In some embodiments, if the guaranteed income system and method 10 does not receive a notice to surrender any paid-up deferred annuities, participants whose paid-up deferred annuities remain in effect can be treated as participants who have made an irrevocable election to have all of their paid-up deferred annuities distributed from the plan. In this instance, such participants can be provided with deferred annuity certificates.

In some embodiments, the rider can include rules or guidelines cessation of contributions to the guaranteed income option. In some embodiments, the guaranteed income system and method 10 can announce if the guaranteed income system and method 10 can cease to allow contributions to be directed to the guaranteed income option for all contracts of this class. In some embodiments, this announcement can be as far in advance of that event as the guaranteed income system and method 10 can reasonably provide, but will not be less than sixty days in advance of the date the guaranteed income system and method 10 can no longer allow contributions to be directed to the guaranteed income option.

In some embodiments, an announcement that the guaranteed income system and method 10 can cease to allow contributions to be directed to the guaranteed income option can be treated a notice to terminate the guaranteed income option.

In some embodiments, the guaranteed income system and method 10 can be configured to accommodate a plan sponsor event. For example, under circumstances where a plan sponsor changes record keepers, the guaranteed income system and method 10 can facilitate various options for the plan sponsor. For example, in some embodiments, the guaranteed income system and method 10 can enable the plan sponsor to choose to have all guaranteed income purchases liquidated. In some embodiments, liquidations can be subject to 90 day free look and early withdrawal charge rules. In some embodiments, the guaranteed income system and method 10 can enable the plan sponsor to choose to allow participants to keep their current investments in guaranteed income. In some embodiments, the deferred income annuity assets can be held in the retirement plan until participants reach a distributable event (i.e. termination, retirement, in-service withdrawal, etc.), or choose to voluntarily liquidate their deferred income annuity investment. In some embodiments, no future contributions to deferred income annuity can be allowed. Further, at the time of the change to the new record keeper, participants who have a premium value of $5,000 or less in deferred income annuity can be subject to the contractual force out (as described above). In some embodiments, the guaranteed income system and method 10 can provide a data feed of the amount of premium and income for each participant to the new service provider for purposes of participant statement information. Further, fee disclosure information and 5500 schedules can also be provided to the plan sponsor, and the guaranteed income system and method 10 can be notified when a plan participant has a distributable event or when they choose to liquidate their deferred income annuity.

In some embodiments, the guaranteed income system and method 10 can enable retirement funds to be distributed to participants. For example, in some embodiments, each guaranteed income purchase can have a 90-day free look period. If a participant chooses to liquidate during the 90-day period, the participant can be subject to a 12 month restriction allowing them to complete an investment transfer into the deferred income annuity (ongoing contributions to the deferred income annuity would continue to be allowed). In some embodiments, after the 90-day period, the liquidation can be subject to the lesser of return of premium or an early withdrawal charge.

Some embodiments of the invention can include provisions for inflation protection. For example, in some embodiments, the guaranteed income system and method 10 can include a consumer price index (hereafter CPI) adjustment. For example, in some embodiments a participant can elect a guaranteed income payment adjustment based on the all-item consumer price index for all urban consumers (CPI-u), as published by the United States Department of Labor. In some embodiments, if a participant elects this feature, on each anniversary of the income start date, the guaranteed income system and method 10 will process a new guaranteed income payment equal to: a) the guaranteed income payment on the income start date, multiplied by b) the CPI-u value for the month that is three calendar months preceding the current anniversary of the income start date, divided by c) the CPI-u value for the month that is three calendar months preceding the income start date. In some embodiments, if the new guaranteed income payment would be less than the current guaranteed income payment, no change can be made. In some embodiments, if the originally published CPI-u value for any month is later revised, the guaranteed income system and method 10 will not recalculate the value. In some embodiments, the guaranteed income system and method 10 can reserve the right to substitute an appropriate index for the CPI-u if: a) the CPI-u is discontinued, delayed, or otherwise not available for this use; or b) the composition or base of, or method of calculating, the CPI-u changes so that the guaranteed income system and method 10 considers it not appropriate for calculating future changes.

Some embodiments of the invention include options for flexible advisor compensation. In some embodiments, the guaranteed income system and method 10 can include provisions for revenue sharing. Further, in some embodiments, the guaranteed income system and method 10 can enable plan pricing that is flexible for paying different levels of advisor compensation (including for example different levels of revenue sharing) up to the time the participant experiences a benefit event. In some embodiments of the invention, the guaranteed income system and method 10 can include provisions for different “rate levels” for purchase rates to accomplish this flexibility.

Some embodiments of the invention include provisions for disclosure to a plan sponsor as a fiduciary. In some embodiments, guaranteed income can be shown as an investment option on retirement plan system and fee summaries, including disclosure of revenue sharing and total cost. In some embodiments, guaranteed income can be treated as an investment option for purpose of disclosure under 408(b)(2). Therefore, in some embodiments, the plan sponsor can receive a description of guaranteed income that can be included in their plan's ERISA 404 retirement plan information and investment notice (notice used to satisfy participant 404(a) disclosure). This notice will follow the guidelines for what information must be disclosed for an annuity under 404a.

In some embodiments, the guaranteed income system and method 10 can provide information describing how much guaranteed income would have been purchased by a hypothetical participant (age “XX”) as of a certain historical date. For example, some embodiments can include an example of $1,000 invested by a participant age 50 on “XX/XX/XXXX” date would have purchased “$xxx” of monthly guaranteed income to begin at age 65. Further, the guaranteed income system and method 10 can be updated for historical dates when the notice is updated (i.e. quarterly). The level of revenue sharing, if any, can be built into the rate level of the purchase rates and can be disclosed, and in some embodiments, the performance and rate of return will not be included in 408(b)(2). Further, the plan sponsor can be issued a contract rider (or other such contract document) for the product.

In some embodiments, the guaranteed income system and method 10 can be configured with provisions for disclosures to plan participants. In some embodiments, participants will receive annual investment information about guaranteed income (as stand-alone investment option, and, as part of a model portfolio). This can be provided by the ERISA 404 retirement plan information and investment notice (this is used to help plan sponsors meet their 404(a) and 404(c) disclosure requirements to participants), and, if applicable, QDIA notice. The information can comprise information about the 90 day free-look period, and can be distributed on the participant plan statement and/or a guaranteed income system and method 10 website. For example, some embodiments can include the notice “This is guaranteed income, go here for more information. You have 90 days after each contribution to change your mind. This is guaranteed for the rest of your life.” In some embodiments, information provided by the guaranteed income system and method 10 can include a history of guaranteed income purchases showing the purchase amount and corresponding guaranteed income amount.

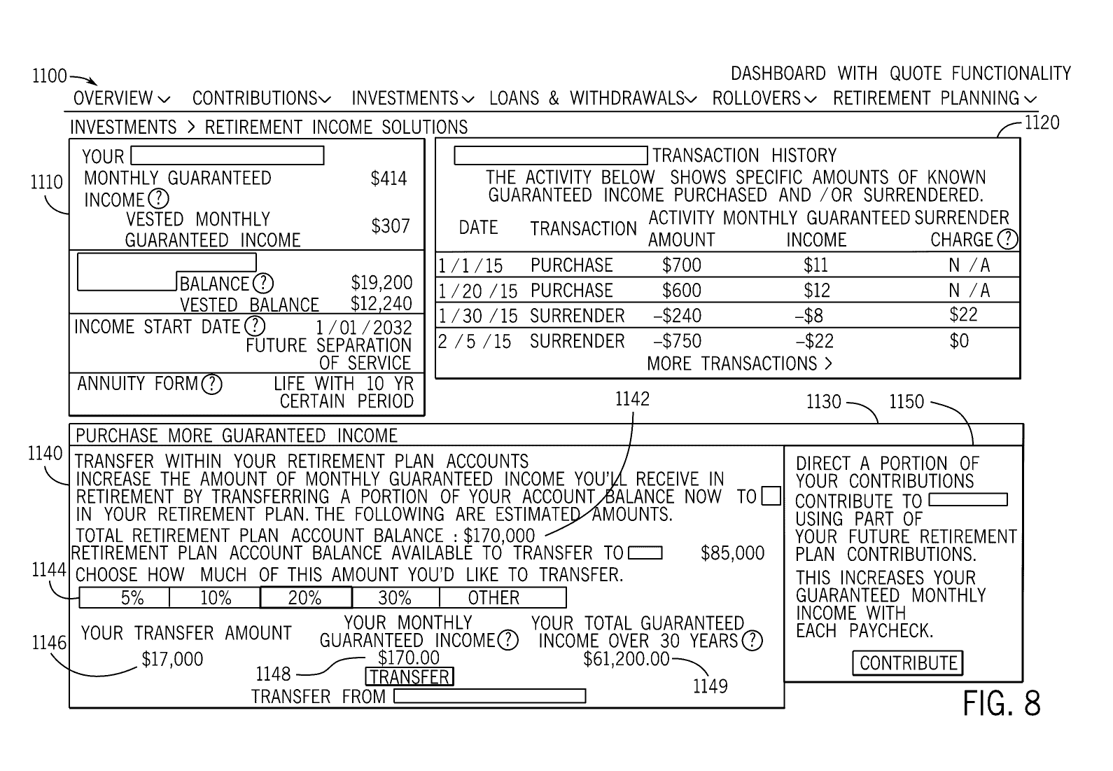

As described earlier with respect to the FIGS. 1-2, in some embodiments, a user (such as a retirement plan customer 105) can access various functional elements of the guaranteed income system and method 10 using an online portal such as one or more display-enabled devices. In some embodiments, the online portal can display one or more information displays or windows that can provide opportunities for a user to review and interact with the displayed information related to deferred income annuity products and services. For example, FIGS. 8-16 illustrate example information and interactive displays generated by the guaranteed income system and method 10 for communicating and receiving information related to deferred income annuity products and services. Referring initially to FIG. 8, illustrating a dashboard with quote functionality 1100, in some embodiments, the guaranteed income system and method 10 can display a dashboard window including various information windows that relate to a deferred income annuity. For example, in some embodiments, the dashboard 1100 can include information windows including a summary window 1110 providing financial details of a deferred income annuity including, but not limited to, the monthly guaranteed income, the vested amount of the guaranteed income, along with the associated total balances for each. In some embodiments, the summary window 1110 can also include the income start date and the annuity form. In some embodiments, the dashboard 1110 can also display a window communicating a customer's current allocation percentage, with an option to change the allocation percentage. Further, in some embodiments, the dashboard 1110 can include a purchase window 1130 including a transfer window 1140 configured to illustrate quotes and projected monthly and total income based on various percentages of fund transfer.

For example, some embodiments include a display of a total retirement account balance 1142, with a percentage selection bar 1144 comprising selectable percentages or amounts to transfer from the account balance 1142. A calculated amount based on the chosen percentage or amount can be shown (“Your transfer amount” 1146), along with a calculated monthly guaranteed income 1148, and total guaranteed income over thirty years (shown as 1149). Further, in some embodiments, a transaction history window 1120 can be provided that can include transaction information related to the customer's deferred annuity (e.g., purchase transaction information and liquidation information, etc.) Further, in some embodiments, the purchase window 1130 can also include a contributions window 1150 configured to enable a user to contribute retirement plan contributions.

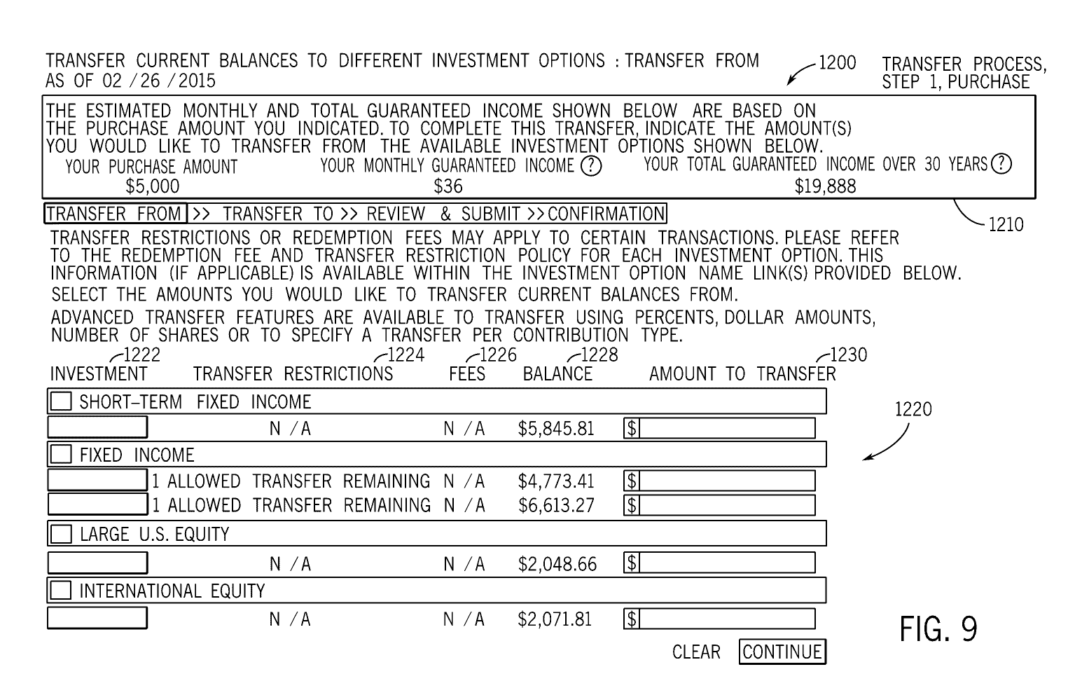

FIGS. 9-12 illustrate information and interactive displays generated by the guaranteed income system and method 10 related to defined annuity purchase transactions. For example, FIG. 9 illustrates a window 1200 of a first step of a transfer process including a purchase in accordance with some embodiments of the invention. In some embodiments, a quote window 1210 can display a hypothetical transfer amount (shown as $5,000 in this non-limiting embodiments) with the deferred income annuity guaranteed monthly income (shown as $36 in this non-limiting embodiment), and deferred total income for an annuity period (e.g., such as 30 years and shown as $19,888 in this non-limiting example embodiment). In some embodiments, if a customer selects to proceed with a transfer of funds from their investments to other investments within the plan, a transfer window (e.g., such as transfer window 1220) can be displayed with options for transfer of funds. In this non-limiting example embodiments, the transfer window 1220 can be displayed including one or more investments (1222), information related to any transfer restrictions for one or more of the displayed investments (1224), fees associated with any transfers from any of the investments (1226), total balances of the investments (1228), and an entry window 1230 configured for a user to enter a transfer amount from one or more of the displayed investment balances.

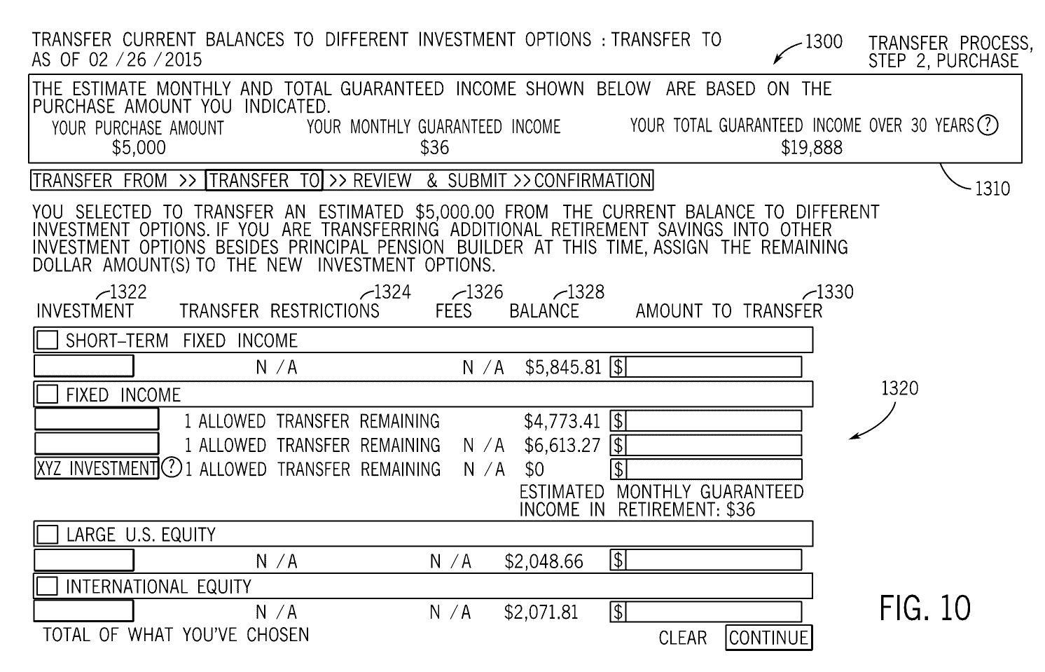

FIG. 10 illustrates a window 1300 of a second step of a transfer process including purchase in accordance with some embodiments of the invention. In some embodiments, guaranteed income system and method 10 can display information related to purchases of the transferred funds selected in the display of FIG. 9 and display in summary window 1310. For example, in some embodiments, once a customer selects to proceed with a transfer of funds from their investments, a purchase window 1320 can be displayed including one or more investments (1322), information related to any transfer restrictions for one or more investments (1324), fees associated with any transfers (1326), total balances of the investments (1328), and an entry window (1330) configured for a user to enter a purchase amount from one or more of the displayed investment balances.

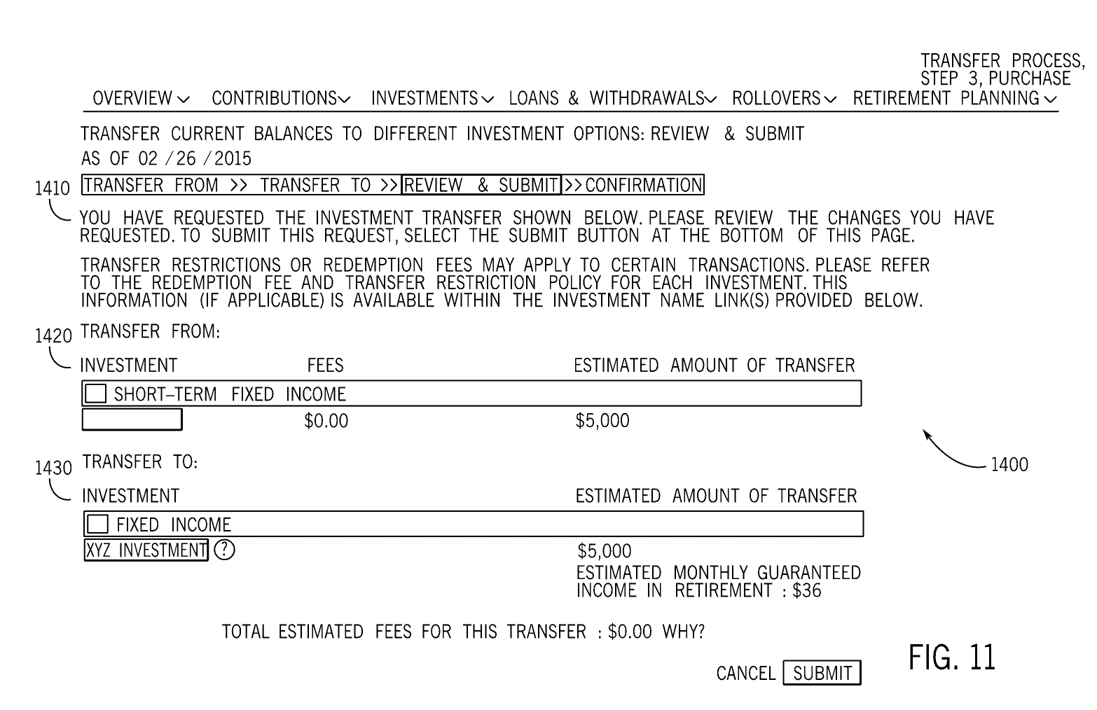

In some embodiments, once a user selects and completes the transfer and purchase selections, the guaranteed income system and method 10 can display a summary of the transaction. For example, FIG. 11 illustrates a window 1400 of a third step of a transfer process including transfer and purchase summary in accordance with some embodiments of the invention. A summary display window 1410 can show the transfer from and transfer to details (shown as transfer from section 1420 and transfer to section 1430), including the respective investments, and the investment amounts for confirmation by the user.

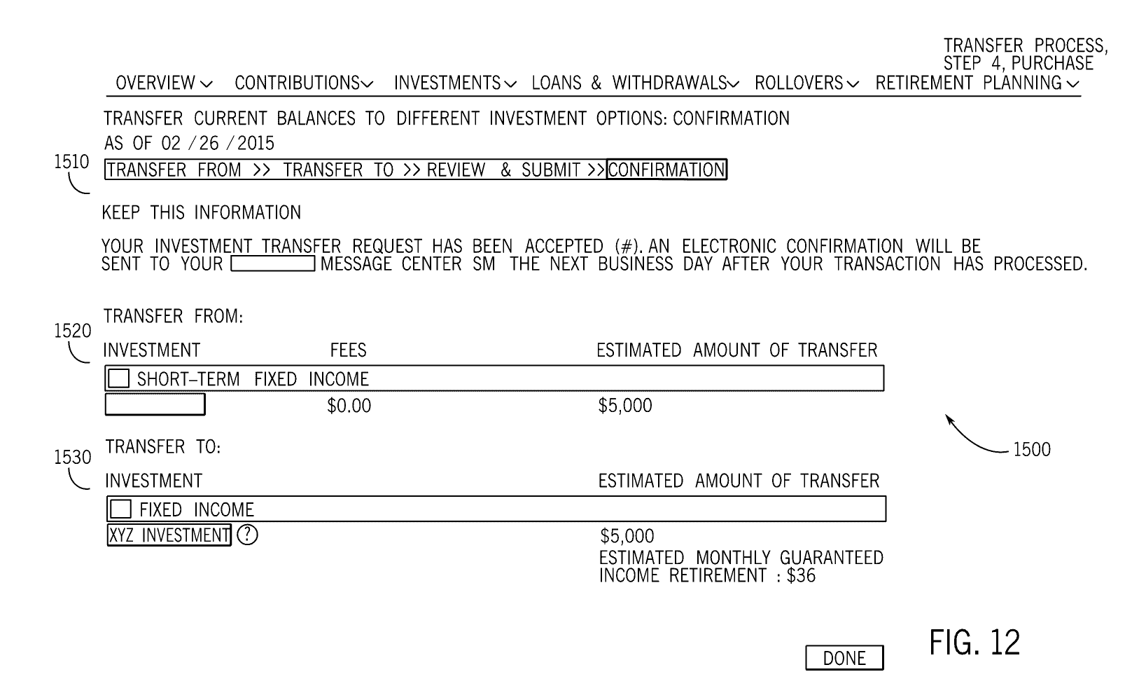

FIG. 12 illustrates a window 1500 of a fourth step of a transfer process including a confirmed purchase in accordance with some embodiments of the invention. A summary display window 1510 can show the transfer from and transfer to details (shown as transfer from section 1520 and transfer to section 1530), including the respective investments, and the investment amounts for confirmation by the user. In some embodiments, following a review of the investment transaction, a user can confirm the transfer and purchase by accessing or clicking “done” within the display as shown.

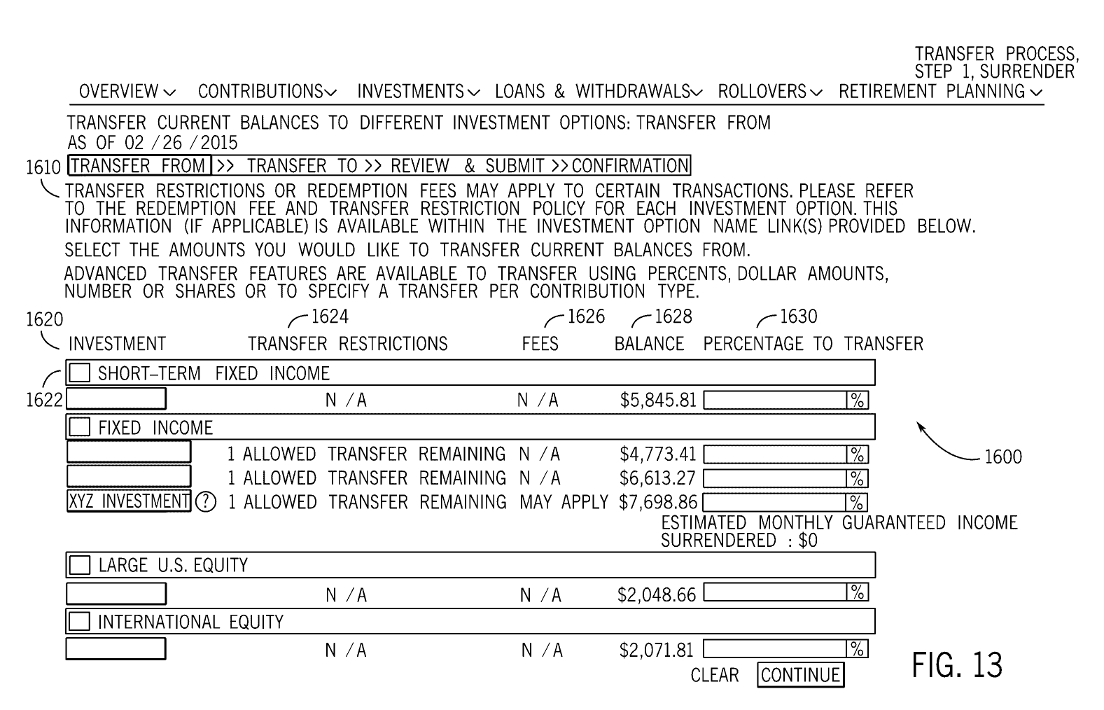

FIGS. 13-16 illustrate information and interactive displays generated by the guaranteed income system and method 10 related to defined annuity surrender transactions. For example, FIG. 13 illustrates a window 1600 of a first step of a transfer process including surrender in accordance with some embodiments of the invention. In some embodiments, guaranteed income system and method 10 can display information related to transfer from one or more investments intended for surrender. In some embodiments, if a customer selects to proceed with a transfer of funds from their investments to other investments within the plan, a transfer window (e.g., such as transfer window 1620) can be displayed. In this non-limiting example embodiment, the transfer window 1220 can be displayed including one or more investments (1622), information related to any transfer restrictions for one or more of the displayed investments (1624), fees associated with any transfers from any of the investments (1626), total balances of the investments (1628), and an entry window 1630 configured for a user to enter a transfer amount from one or more of the displayed investment balances (e.g., as a percentage).

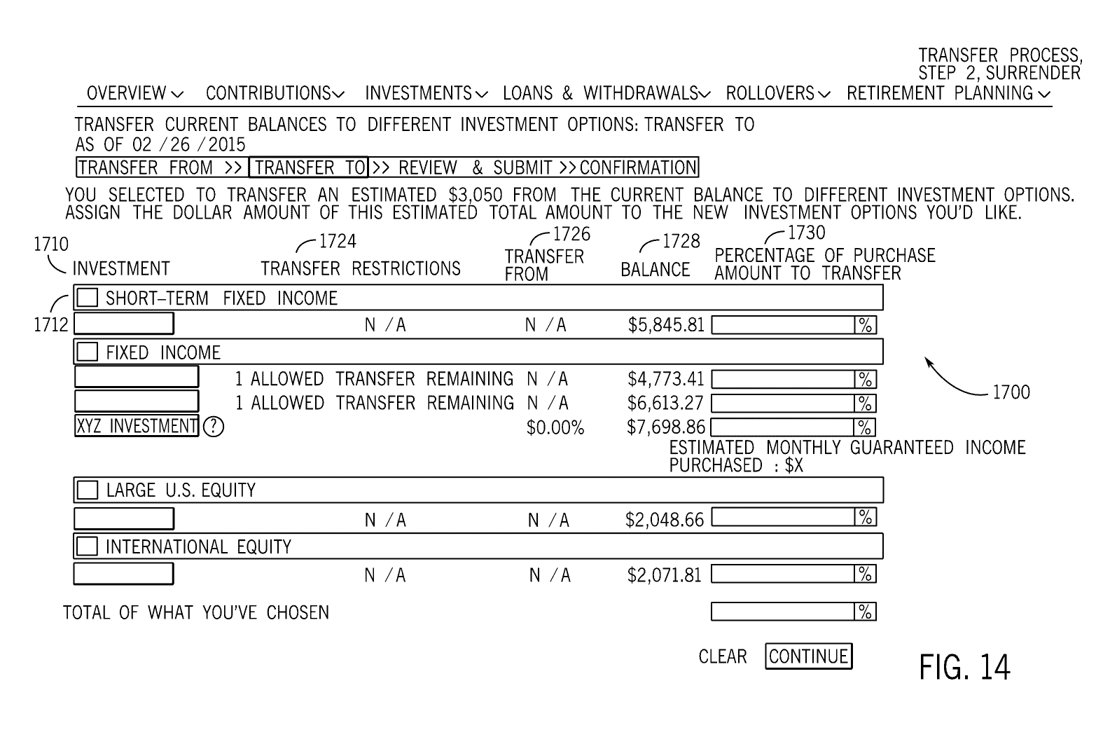

FIG. 14 illustrates a window 1700 of a second step of a transfer process including a transfer to purchase in accordance with some embodiments of the invention. In some embodiments, the guaranteed income system and method 10 can display information related to balances of the transferred funds selected in the window 1600 of FIG. 13. In some embodiments, if a customer selects to proceed with a transfer of funds from their investments to other investments within the plan, a window 1710 can be displayed including one or more investments (1712), information related to any transfer restrictions for one or more of the displayed investments (1724), a transfer from amount 1726, total balances of the investments (1728), and an entry window 1730 with transfer amount selection. In some embodiments, once a customer selects to proceed with a transfer of funds from their investments for surrender, a purchase amount to transfer window can be displayed including one or more investments, information related to any transfer restrictions for one or more investments, fees associated with any transfers, total balances of the investments, and an entry window configured for a user to enter a purchase amount from one or more of the displayed investment balances.

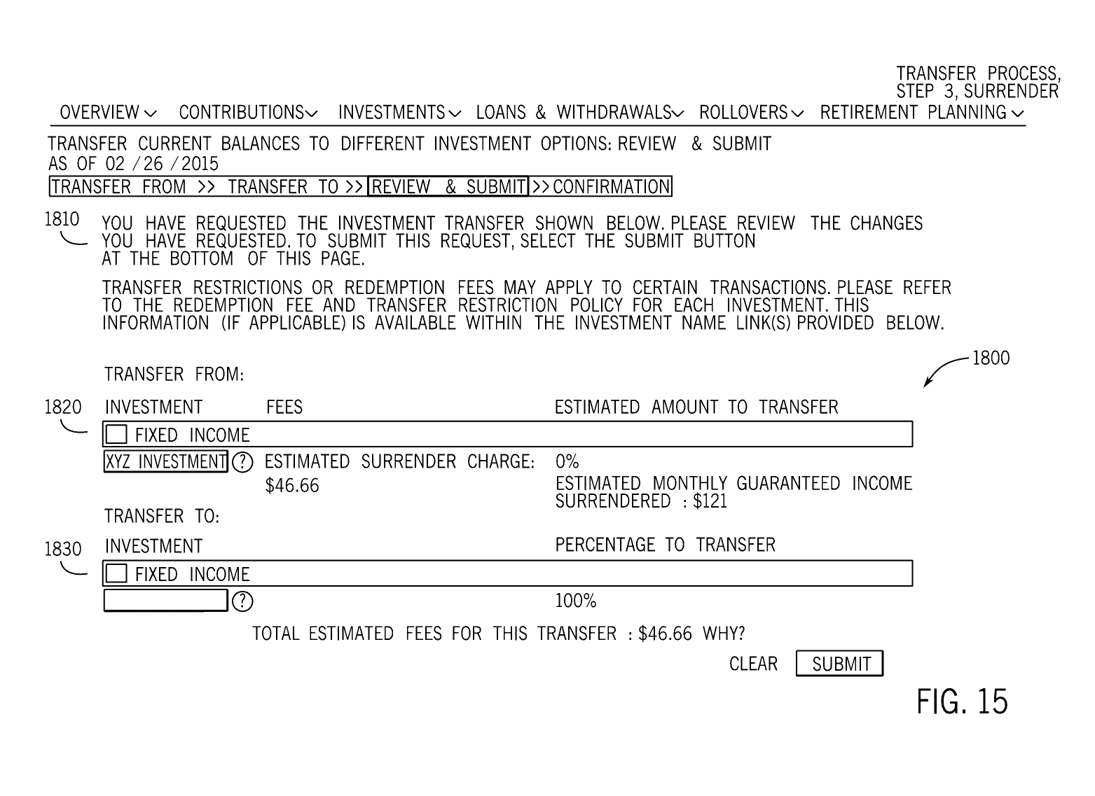

In some embodiments, once a user selects and completes the transfer from and transfer to purchase selections, the guaranteed income system and method 10 can display a summary of the transaction. For example, FIG. 15 illustrates a window 1800 of a third step of a transfer process including transfer and purchase summary 1810 in accordance with some embodiments of the invention. The summary 1810 can show the transfer from (1820) and transfer to (1830) details, including the respective investments, and the investment amounts for confirmation by the user.

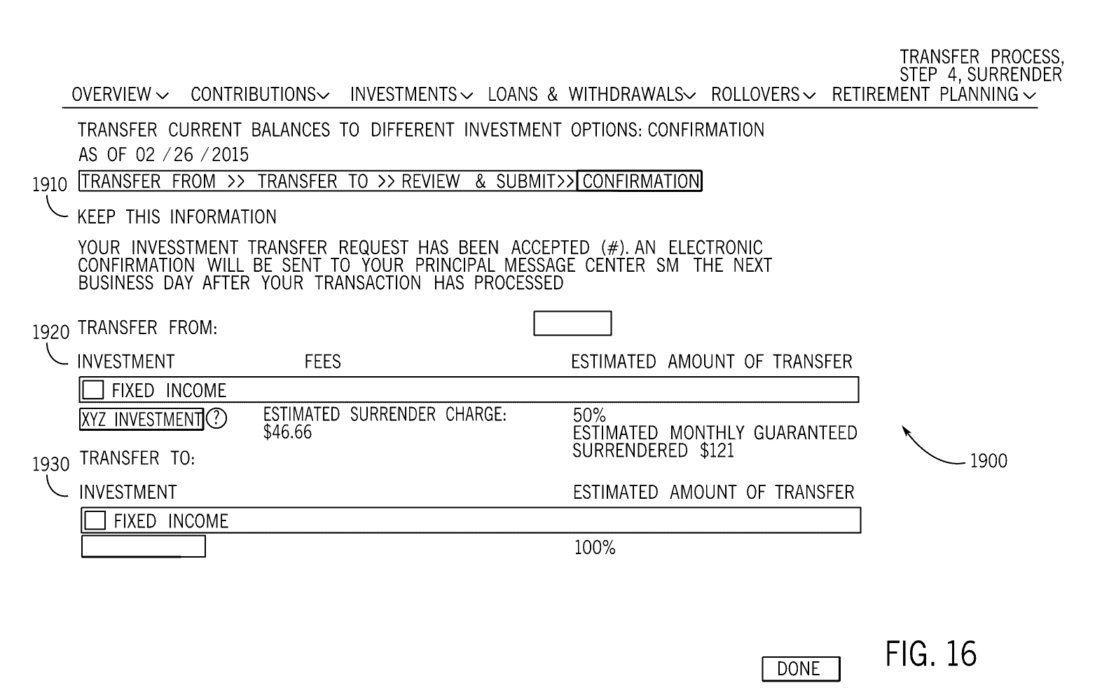

FIG. 16 illustrates a window 1900 of a fourth step of a transfer process including a confirmed transfer purchase in accordance with some embodiments of the invention. The summary 1910 can show the transfer from (1920) and transfer to (1930) details, including the respective investments, and the investment amounts for confirmation by the user. In some embodiments, following a review of the investment transaction, a user can confirm the transfer and purchase by accessing or clicking “done” within the display as shown.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A guaranteed income server system comprising:
a computing device comprising at least one processor;
a non-transitory computer readable medium, having stored thereon, instructions that when executed by the computing device, cause the computing device to perform at least some operations within a local or consumer device, the operations comprising at least:
execution of a browser program to deliver pension plan financial content on the local or consumer device;
displaying at least one selectable option of a financial structure of a financial portfolio, the financial portfolio including an allocation to at least one investment option selectable as part of a pension;
coupling to an investment database comprising pre-modeling investment data, and to a third-party source of financial models, the financial models based at least in part on the pre-modeling investment data;
calculating and displaying at least one pension glide path option or scenario comprising a representation of how the financial portfolio will be managed over time based at least in part on at least one of the financial models;
receiving at least a target date input from a user through the local or consumer device;
calculating and displaying purchase cost options based on the target date input;
receiving at least one purchase selection;
storing the received purchase selection in a data repository; and
calculating and displaying at least one pension glide path of the pension based at least in part on at least one of the financial models, the target date, and the at least one purchase selection.

2. The server system of claim 1, wherein the at least one purchase comprises at least one lump sum purchase.

3. The server system of claim 1, wherein the at least one purchase comprises at least one payroll income purchase, the at least one payroll income purchase comprising a value defined by at least one of the financial models based on the target date and any lump sum payment by the customer.

4. The server system of claim 1, wherein the at least one purchase comprises customer funds transferred from one or more existing investment accounts of the customer.

5. The server system of claim 4, wherein the existing investment accounts comprise a plurality of investments and wherein customer funds are transferred proportionally to make the purchase.

6. The server system of claim 1, further comprising providing an option to redeem at least a portion of a pension.

7. The server system of claim 6, wherein upon a redemption, the at least one pension glide path of the pension is recalculated based at least in part on the at least one purchase selection and a redeemed portion of the pension.

8. The server system of claim 6, wherein a redemption can trigger a redemption surcharge based at least in part on one or more rules of the pension.

9. The server system of claim 1, wherein the target date investment option includes at least one investment or investment plan structured or defined by a specified retirement target date.

10. The server system of claim 1, wherein the at least one pension glide path option or scenario includes a display of at least one of a financial data chart and a financial data table.

11. The server system of claim 10, wherein the financial data chart or financial data table includes a display of purchased income and resulting total income as a function of the customer's age and time period.

12. The server system of claim 11, wherein the time period comprises a monthly time period for purchased income and resulting total income as a function of the customer's age.

13. The server system of claim 11, wherein the pension comprises at least one of a deferred income annuity and a target date investment fund.

14. The server system of claim 13, configured to enable the deferred income annuity comprises at least one of a QLAC annuity, an irrevocable annuity, or an immediate annuity.

15. The server system of claim 11, wherein the purchase selection comprises a purchase amount provided by the customer.

16. The server system of claim 11, wherein the purchase selection comprises an employer profit sharing contribution and/or matching contribution.

17. The server system of claim 16, wherein the employer profit sharing contribution and/or matching contribution is directed by a plan sponsor.

18. The server system of claim 11, wherein the at least one pension glide path option or scenario is structured based on a fixed allocation model.

19. The server system of claim 11, wherein the at least one pension glide path option or scenario is structured based on a glide path that includes provisions to prepare an increasingly conservative financial portfolio as the customer's age approaches the target date.

20. A guaranteed income method comprising:
providing a computing device comprising at least one processor;
providing a non-transitory computer readable medium, having stored thereon, instructions that when executed by the computing device, cause the computing device to perform at least some operations within a local or consumer device, the operations comprising at least:
execution of a browser program to deliver pension plan financial content on the local or consumer device;
displaying at least one selectable option of a financial structure of a financial portfolio, the financial portfolio including an allocation to at least one investment option selectable as part of a pension;
coupling to an investment database comprising pre-modeling investment data, and to a third-party source of financial models, the financial models based at least in part on the pre-modeling investment data;
calculating and displaying at least one pension glide path option or scenario comprising a representation of how the financial portfolio will be managed over time based at least in part on at least one of the financial models;
receiving at least a target date input from a user through the local or consumer device;
calculating and displaying purchase cost options based on the target date input;
receiving at least one purchase selection;
storing the received purchase selection in a data repository; and
calculating a guaranteed income pension based at least in part on at least one of the financial models, the target date, and the at least one purchase selection.
